(19) United States
(12) Patent Application Publication
(10) Pub. No.: US 2019/0005077 A1
(43) Pub. Date: Jan. 3, 2019

(54) RETRIEVAL SYSTEM AND RETRIEVAL APPARATUS

(71) Applicant: Takeshi MATSUDA, Tokyo (JP)

(72) Inventor: Takeshi MATSUDA, Tokyo (JP)

(73) Assignee: Ricoh Company, Ltd., Tokyo (JP)

(21) Appl. No.: 15/741,355

(22) PCT Filed: Aug. 22, 2016
(86) PCT No.: PCT/JP2016/003806

§ 371 Date: Jan. 2, 2018

(30) Foreign Application Priority Data
Aug. 26, 2015 (JP) 2015-166703

(51) Int. Cl. G06F 17/30

(52) U.S. Cl. CPC G06F 17/30321

(57) ABSTRACT

A retrieval system retrieves content data stored in a database using an index. The retrieval system includes a first registration unit configured to register a set definition including an index object item indicating a data item serving as the index and an acquisition condition for acquiring the content data from the database; an acquisition unit configured to acquire, when the set definition is registered by the first registration unit, content data included in the set definition, which satisfy the acquisition condition, from the database; and a generation unit configured to extract the index object item included in the set definition, to generate the index, in the content data acquired by the acquisition unit.

### TECHNICAL FIELD

The disclosure herein generally relates to a retrieval system and a retrieval apparatus.

### BACKGROUND ART

Conventionally, retrieval systems for retrieving target content data from a database storing content data such as documents have been known. Retrieving methods used in such retrieval systems include a method referred to as an attribute retrieval or an item retrieval in which specific data items included in content data are prepared in advance as indices and a retrieval is performed by using the indices.

Moreover, techniques of creating indices by using format data of documents have been conventionally known (See, for example, Patent document 1).

### CITATION LIST

### Patent Literature

PTL 1: Japanese Patent No. 2549745

### SUMMARY OF INVENTION

### Technical Problem

However, in the above-described prior art, when a database includes content data, data structures of which are different from each other, an index common to these content data may not be created.

For example, assume that data items of a piece of content data are “title”, “creator” and “main body”, and data items of another piece of content data are “photographing date”, “creator” and “photographer”. In this case, an index to be commonly used for retrieving these content data including data items “title” and “creator” as retrieval keys, for example, cannot be created.

An embodiment of the present invention is made in consideration of the above-described problem, and aims at creating indices used for retrieving content.

### Solution to Problem

According to an aspect of the invention, a retrieval system retrieves content data stored in a database using an index. The retrieval system includes a first registration unit configured to register a set definition including an index object item indicating a data item serving as the index and an acquisition condition for acquiring the content data from the database; an acquisition unit configured to acquire, when the set definition is registered by the first registration unit, content data included in the set definition, which satisfy the acquisition condition, from the database; and a generation unit configured to extract the index object item included in the set definition, to generate the index, in the content data acquired by the acquisition unit.

### Advantageous Effects of Invention

According to embodiments of the present invention, indices used for retrieving content can be created.

### BRIEF DESCRIPTION OF DRAWINGS

FIG. 1 is a diagram depicting an example of a system configuration of a retrieval system according to a first embodiment.

FIG. 2 is a diagram depicting an example of a hardware configuration of a computer according to the first embodiment.

FIG. 3 is a diagram depicting an example of a functional configuration of the retrieval system according to the first embodiment.

FIG. 4A is a diagram depicting an example of a content DB.

FIG. 4B is a diagram depicting another example of the content DB.

FIG. 4C is a diagram depicting yet another example of the content DB.

FIG. 5 is a diagram depicting an example of a set definition DB.

FIG. 6A is a diagram depicting an example of a content set DB.

FIG. 6B is a diagram depicting another example of the content set DB.

FIG. 6C is a diagram depicting yet another example of the content set DB.

FIG. 7 is a sequence diagram depicting an example of a process for registering set definition according to a first embodiment.

FIG. 8 is a diagram depicting an example of a screen for registering set definition.

FIG. 9 is a flowchart depicting an example of a process for creating content set according to the first embodiment.

FIG. 10 is a sequence diagram depicting an example of a process for registering content according to the first embodiment.

FIG. 11 is a diagram depicting an example of a screen for registering content.

FIG. 12 is a flowchart depicting an example of a process for adding to content set according to the first embodiment.

FIG. 13 is a sequence diagram depicting an example of a process for displaying content set according to the first embodiment.

FIG. 14A is a diagram depicting an example of content list screen.

FIG. 14B is a diagram depicting another example of content list screen.

FIG. 15 is a sequence diagram depicting an example of a process of retrieving content according to the first embodiment.

FIG. 16A is a diagram depicting an example of a content retrieval screen.

FIG. 16B is a diagram depicting an example of a retrieval result screen.

FIG. 17 is a diagram depicting an example of a functional configuration of a retrieval system according to a second embodiment.

FIG. 18 is a sequence diagram depicting an example of a process for updating set definition according to the second embodiment.

FIG. 19 is a diagram depicting an example of a screen for updating set definition.

FIG. 20 is a diagram depicting an example of a functional configuration of a retrieval system according to a third embodiment.

FIG. 21 is a sequence diagram depicting an example of a process of deleting content according to the third embodiment.

FIG. 22 is a diagram depicting an example of a screen for deleting content.

FIG. 23 is a flowchart depicting an example of a process for updating content set according to the third embodiment.

### DESCRIPTION OF EMBODIMENTS

In the following, embodiments of the present invention will be described with reference to the accompanying drawings.

### First Embodiment

<System Configuration>

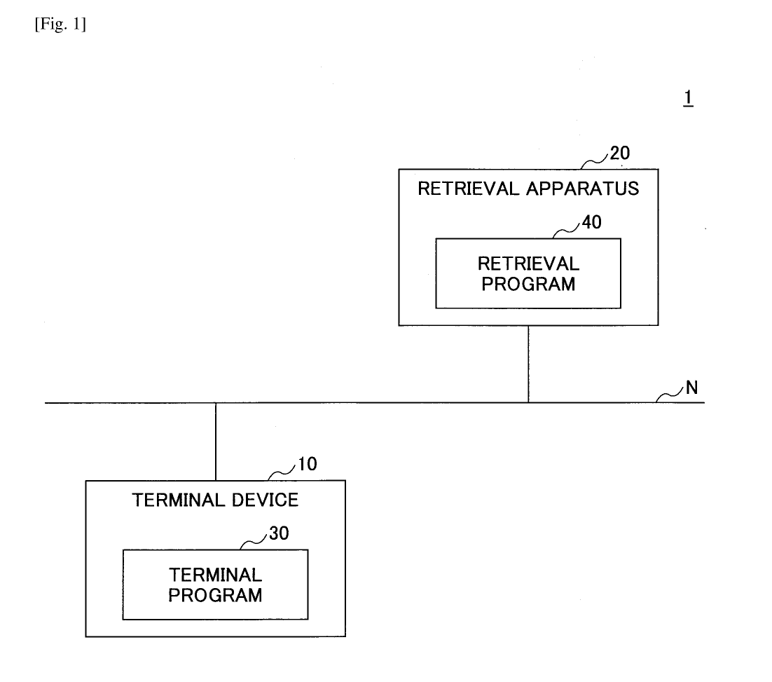

At first, a retrieval system 1 according to a first embodiment will be described with reference to FIG. 1. FIG. 1 is a diagram depicting an example of a system configuration of the retrieval system according to the first embodiment.

The retrieval system 1 illustrated in FIG. 1 includes a terminal device 10 and a retrieval apparatus 20, which are coupled to each other for a communications connection via a network N such as a Local Area Network (LAN).

The terminal device 10 is electronic equipment such as a desktop PC, a laptop PC, a smartphone, or a tablet type terminal that a user of the retrieval system 1 uses. In the terminal device 10, a terminal program 30 for retrieving content registered in the retrieval apparatus 20 is installed. Therefore, the user can retrieve the content registered in the retrieval apparatus 20 using the terminal program 30 installed in the terminal device 10.

Moreover, the user can register in the retrieval apparatus 20 an index used for retrieval of content by using the terminal program 30 installed in the terminal device 10.

Here, content is, for example, a document such as a report or a billing statement, an image, a moving picture, music, application program or the like. Therefore, content data indicating content are document data, image data, moving picture data, music data, program data or the like that are registered in the retrieval apparatus 20 and serve as a retrieval object.

In this way, various contents are assumed to be registered in the retrieval apparatus 20 according to the embodiment. In other words, various content data having different data structures are registered in the retrieval apparatus 20 according to the embodiment. In addition, data structures of content data of the same kind can be different from each other. For example, data structure of document data of a report can be different from data structure of document data of a billing statement.

The retrieval apparatus 20 is an information processing apparatus that manages contents or indices. In the retrieval apparatus 20, a retrieval program 40 for performing creation or registration of an index, or retrieval of content data by using an index, is installed.

In the embodiment, the retrieval program 40 is installed in the retrieval apparatus 20, and thereby an index common to various content data having different data structures can be created and registered. Therefore, in the retrieval apparatus 20 according to the embodiment, content data having various data structures can be retrieved by using the common index.

Moreover, in the retrieval apparatus 20 according to the embodiment, even when a data structure of content data that have already been stored is changed or the like, an index for retrieving the content data does not need to be regenerated or the like. In other words, in the retrieval apparatus 20 according to the embodiment, without affecting indices, the data structure of the stored content data can be changed dynamically.

In addition, the example illustrated in FIG. 1 indicates a case where the retrieval apparatus 20 is an information processing apparatus. However, the retrieval apparatus 20 may be two or more information processing apparatuses.

<Hardware Configuration>

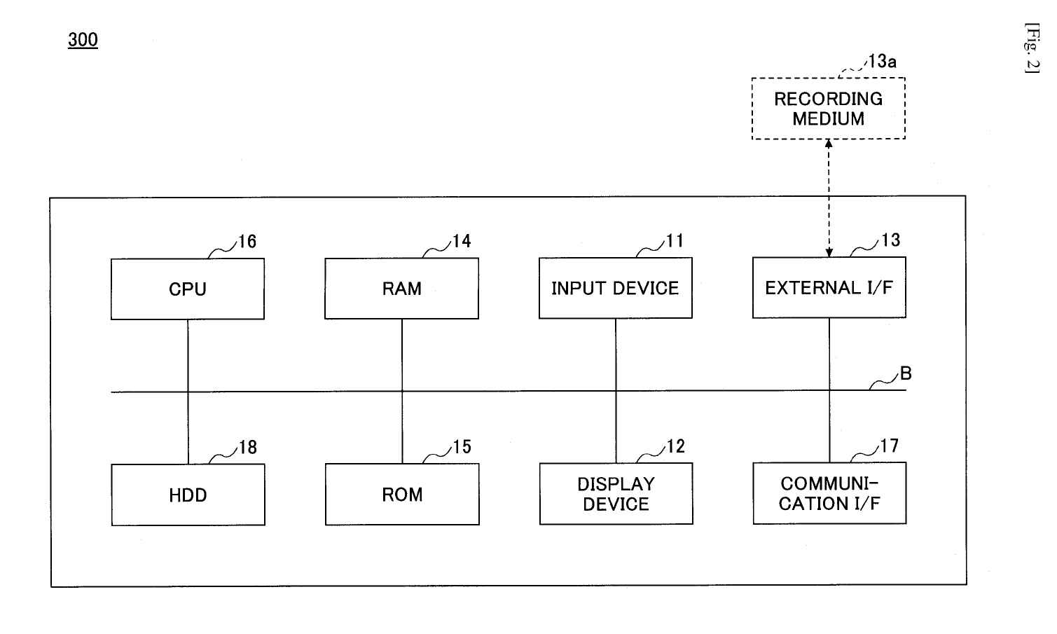

Next, hardware configuration of the terminal device 10 and the retrieval apparatus 20 according to the first embodiment will be described with reference to FIG. 2. FIG. 2 is a diagram depicting an example hardware configuration of a computer according to the first embodiment.

The computer 300 illustrated in FIG. 2 includes an input device 11, a display device 12, an external I/F 13, and a RAM (Random Access Memory) 14. Moreover, the computer 300 further includes a ROM (Read-Only Memory) 16, a communication I/F 17, and a HDD 18. The respective hardware members are coupled to each other via a bus B.

The input device 11 includes a keyboard, a mouse, a touch panel or the like, and is used for inputting various kinds of signals in the computer 300. The display device 12 includes a display or the like, and displays results of various processes. In addition, the retrieval apparatus 20 may use, when necessary, the input device 11 and/or the display device 12 by connecting to the bus B.

The external I/F 13 is an interface to the external device. The external device includes, for example, a recording medium such as a CD (Compact Disk), a DVD (Digital Versatile Disk), an SD memory card, or a USB (Universal Serial Bus) memory. The computer 300 can read out from and/or write into the recording medium via the external I/F 13.

The RAM 14 is a volatile semiconductor memory (storage device) that temporarily stores a program or data. The ROM 15 is a non-volatile semiconductor memory (storage device) that can retain data even when an electric power is OFF. The CPU 16 is an arithmetic device that reads a program or data from the HDD 18, the ROM 15 or the like onto the RAM 14, and executes various processes.

The communication I/F 17 is an interface for connecting the computer 300 to the network N.

The HDD 18 is a non-volatile memory (storage device) storing a program or data. A program or data stored in the HDD 18 include, for example, the terminal program 30, the retrieval program 40, OS (Operating System) that is basic software controlling the whole computer 300, various programs operating on the OS, or the like. The computer 300 may use a non-volatile memory (storage device) such as an SSD (Solid State Drive) instead of or along with the HDD 18.

The terminal device 10 and the retrieval apparatus 20 according to the embodiment enable various processes which will be described later by the computer 300 illustrated in FIG. 2.

<Functional Configuration>

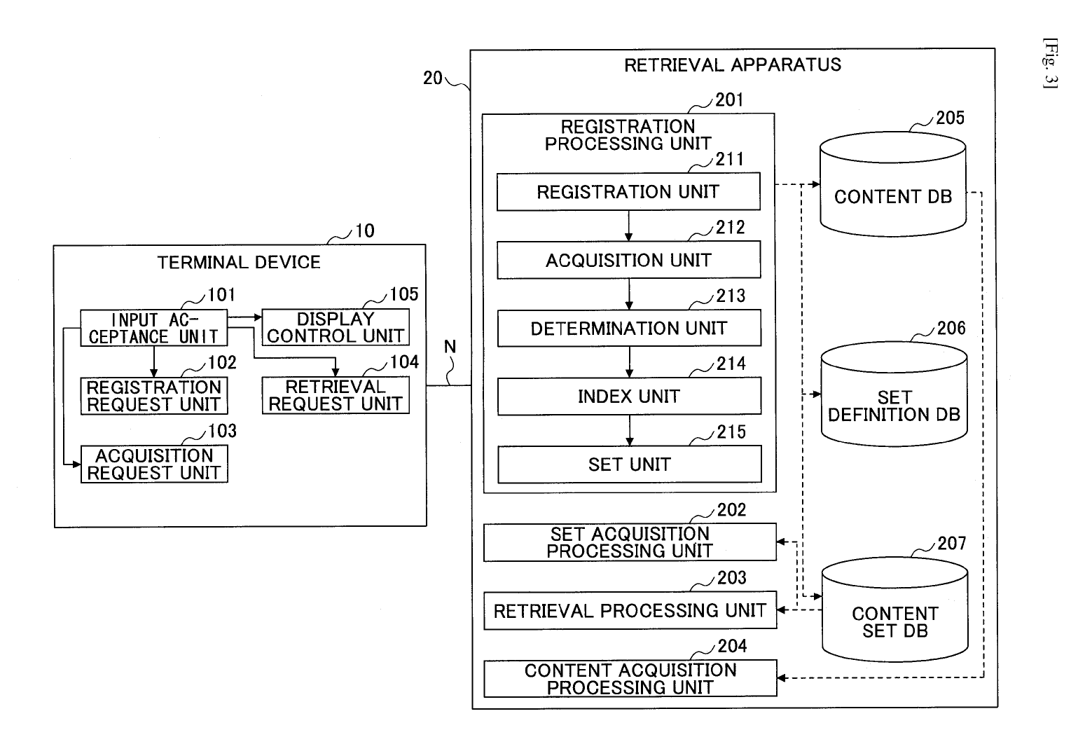

Next, a functional configuration of the retrieval system 1 according to the first embodiment will be described with reference to FIG. 3. FIG. 3 is a diagram depicting an example functional configuration of the retrieval system according to the first embodiment.

The terminal device 10 illustrated in FIG. 3 includes an input acceptance unit 101, a registration request unit 102, an acquisition request unit 103, a retrieval request unit 104, and a display control unit 105. The respective units are enabled by processing that the terminal program 30 installed in the terminal device 10 causes the CPU 16 to execute.

The input acceptance unit 101 accepts various input operations from the user. For example, the input acceptance unit 101 accepts an operation of registering set definition in order to generate an index, or a content registration operation for registering content. Moreover, for example, the input acceptance unit 101 accepts a retrieval operation for retrieving content or a display operation for displaying content.

Here, in the retrieval system according to the embodiment, based on set definition configured (defined) by the user, a content set which is a subset of the content registered in the retrieval apparatus 20 is generated. Then, in the retrieval system 1 according to the embodiment, the content set generated based on the set definition is used as an index. The set definition and the content set will be described later in detail.

The registration request unit 102 sends a request for registration of set definition or a request for registration of content to the retrieval apparatus 20 in response to the input operation accepted by the input acceptance unit 101.

The acquisition request unit 103, in response to the input operation accepted by the input acceptance unit 101, sends a request for acquisition of content set in order to display the content set on the display device 12 to the retrieval apparatus 20. Moreover, the acquisition request unit 103, in response to the input operation accepted by the input acceptance unit 101, sends a request for acquisition of content in order to display the content selected by the user on the display device 12 to the retrieval apparatus 20.

The retrieval request unit 104, in response to the input operation accepted by the input acceptance unit 101, sends a request for retrieval of content in order to retrieve desired content from content set to the retrieval apparatus 20.

The display control unit 105 displays various screens on the display device 12. For example, the display control unit 105, in response to the input operation accepted by the input acceptance unit 101, displays a registration screen for set definition, a registration screen for content, or the like on the display device 12. Moreover, for example, the display control unit 105, in response to a reply from the retrieval apparatus 20, displays a content list screen for displaying content sets managed in the retrieval apparatus 20, a retrieval result screen retrieved in the retrieval apparatus 20, or the like on the display device 12.

The retrieval apparatus 20 illustrated in FIG. 3 includes a registration processing unit 201, a set acquisition processing unit 202, a retrieval processing unit 203, and a content acquisition processing unit 204. The respective units are enabled by processing that the retrieval program 40 installed in the retrieval apparatus 20 causes the CPU 16 to execute.

Moreover, the retrieval apparatus 20 illustrated in FIG. 3 includes a content database 205, a set definition database 206, and a content set database 207. The respective databases (in the following, referred to as “DB”) are enabled by the HDD 18.

The respective DBs may be enabled by a storage device or the like, coupled to the retrieval apparatus 20 via the network N. That is, the retrieval apparatus 20 may be coupled via the network N to a DB server including at least one of the content database 205, the set definition DB 206, and the content set database 207.

The registration processing unit 201 performs a registration process for set definition and a registration process for content. Here, the registration process for set definition is a process of generating a content set based on a set definition defined by the user. On the other hand, the registration process for content is a process of registering a content created by the user and appending the content to a corresponding content set. The registration processing unit 201 includes a registration unit 211, an acquisition unit 212, a determination unit 213, an index unit 214, and a set unit 215. The respective units will be described later in detail.

The set acquisition processing unit 202, in response to an acquisition request for content set, acquires content set data configuring content set from the content set DB 207.

The retrieval processing unit 203, in response to a retrieval request for content, retrieves content set and acquires content set data.

The content acquisition processing unit 204, in response to an acquisition request for content, acquires corresponding content data from the content DB 205.

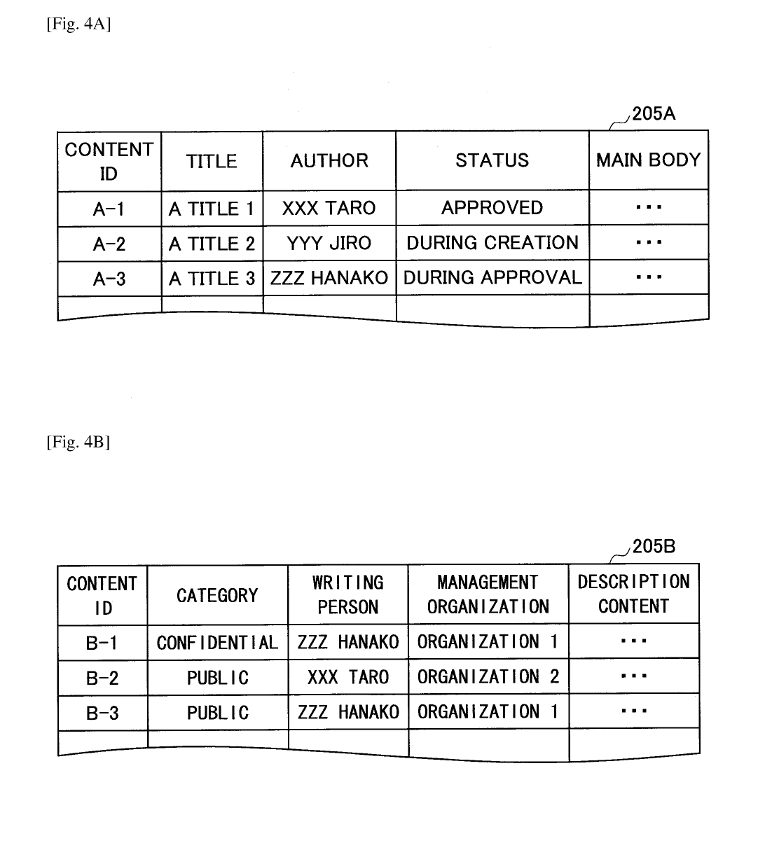

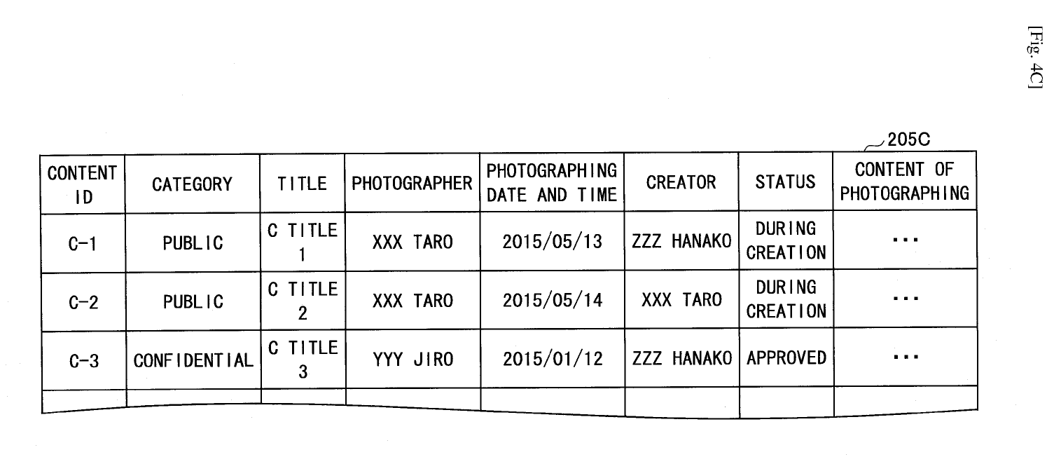

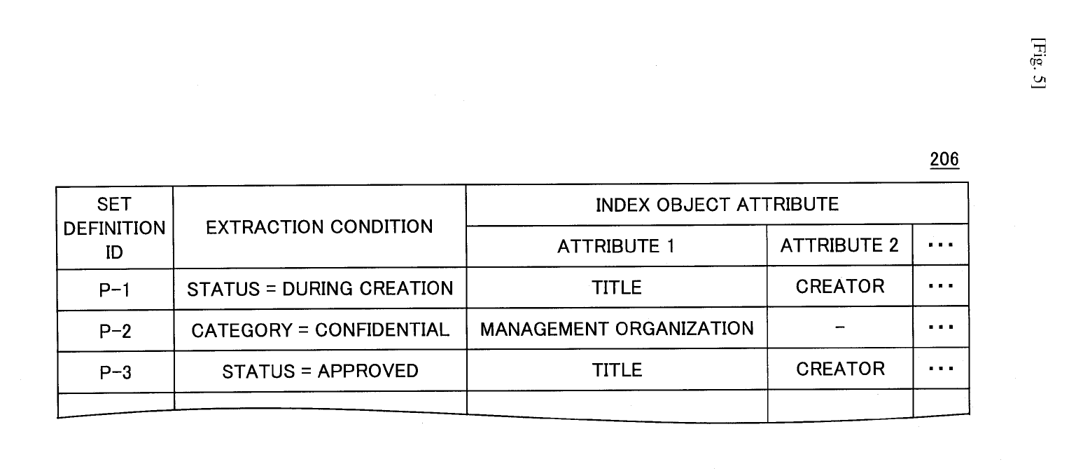

The content DB 205 manages content data indicating content. Here, the content DB 205 will be described in detail with reference to FIGS. 4A to 4C. FIGS. 4A to 4C are diagrams depicting an example of the content DB.

In the content DB 205, content data indicating a plurality of kinds of contents are managed. That is, in the content DB 205, as illustrated in FIGS. 4A to 4C, for example, content data having different data structures are managed. That is, in the content DB 205, content tables 205A to 205C storing respectively content data having data structures different from each other are stored.

In the content table 205A illustrated in FIG. 4A, for example, content data indicating reports are stored. Content data stored in the content table 205A includes, as data items, content ID, title, creator, status, and main body. The content ID is identification information for uniquely identifying content data in the retrieval system 1. The title is a name of title of the report. The creator is a name of a user who creates the report. The status is information indicating which of the report while being created, the report being processed for approval, and the report being approved, for example. The main body is content of the report.

The content table 205B illustrated in FIG. 4B stores content data indicating a design specification, for example. Content data stored in the content table 205B includes, as data items, content ID, category, writing person, management organization, and description content. The content ID is, in the same as above, identification information for uniquely identifying content data. The category is information indicating, for example, which of the design specification being a confidential document and the design specification being a public document. The writing person is a name who writes the design specification. The management organization is a name or organization that manages the design specification. The description content is a design content of the design specification.

The content table 205C illustrated in FIG. 4C stores content data of video recorded conference. Content data stored in the content table 205C includes, as data items, content ID, category, title, photographer, photographing date and time, creator, status, and content of photographing. The content ID is, in the same as above, identification information for uniquely identifying content data. The category is information indicating, for example, which of the content data being confidential data and the content data being public data. The title is a name of title of the content data. The photographer is a name of a person who video records the conference. The photographing date and time is date and time when the conference is video recorded. The creator is a name of a user who creates the content data. The status is information indicating which of the content data being created, the content data awaiting approval and the content data being approved, for example. The content of photographing is content video recorded.

As described above, in the content DB 205 of the retrieval apparatus 20 according to the embodiment, content data having various data structures are managed. In the above description, the case where content data of three kinds of data structures are stored in the content DB 205 is illustrated. However, not limited to this, in the content DB 205, arbitrary kinds of content data may be stored.

The set definition DB 206 manages set definition data indicating set definition in order to generate a content set. Here, the set definition DB 206 will be described in detail with reference to FIG. 5. FIG. 5 is a diagram depicting an example of a set definition DB.

Set definition data stored in the set definition DB 206 illustrated in FIG. 5 include, as data items, set definition ID, extraction condition, and index object attribute. The set definition ID is identification information for uniquely identifying set definition data in the retrieval system 1. The extraction condition is a condition for extracting content data from the content DB 205. The index object attribute is a data item (attribute) of content data serving as an index.

For example, in set definition data of set definition ID “P-1”, the extraction condition is “status=during creation”, and the index object attribute is “title” and “creator”. This indicates extracting content data, in which the data item “status” is “during creation”, from the content DB 205, and generating a content set where the data items “title” and “creator” of the extracted content data are content set data.

Similarly, for example, set definition data of set definition ID “P-2”, the extraction condition is “category=confidential” and index object attribute is “management organization”. This indicates extracting content data, in which the data item “category” is “confidential”, from the content DB 205, and generating a content set where the data item “management organization” of the extracted content data is content set datum.

As described above, in the set definition DB 206 of the retrieval apparatus 20 according to the embodiment, set definition data for generating content set data are managed. As described later, set definition indicated by the set definition data is defined (configured) by the user and registered in the retrieval apparatus 20.

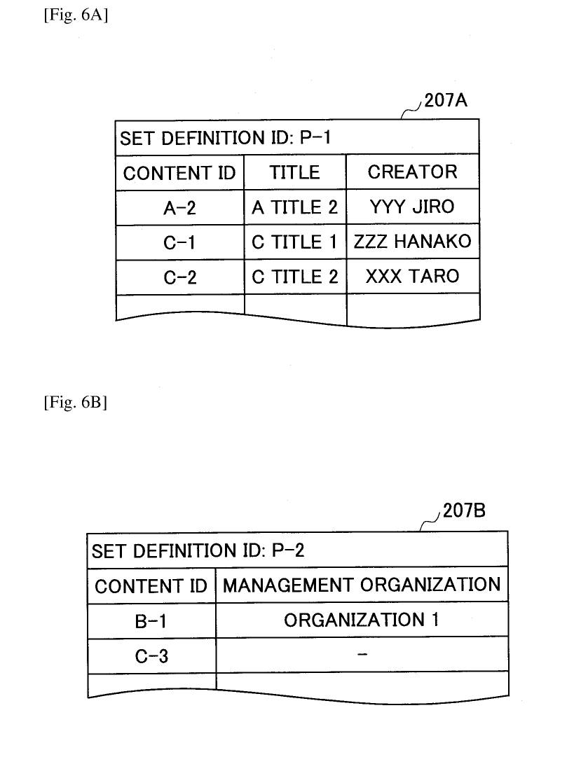

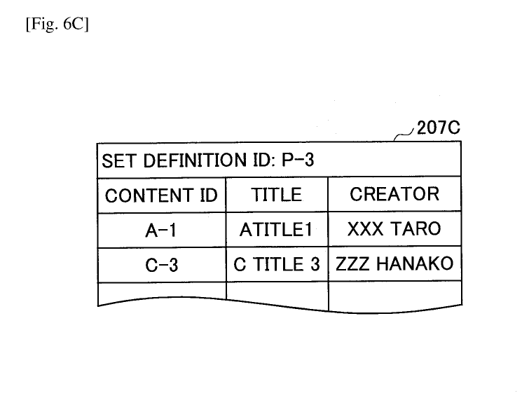

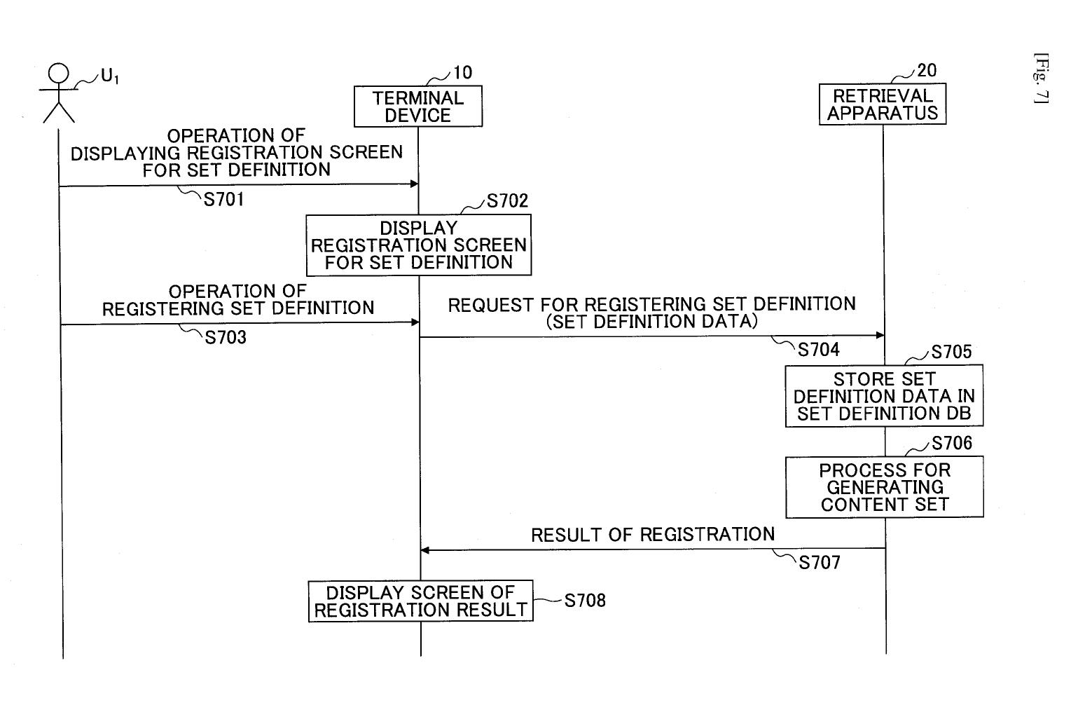

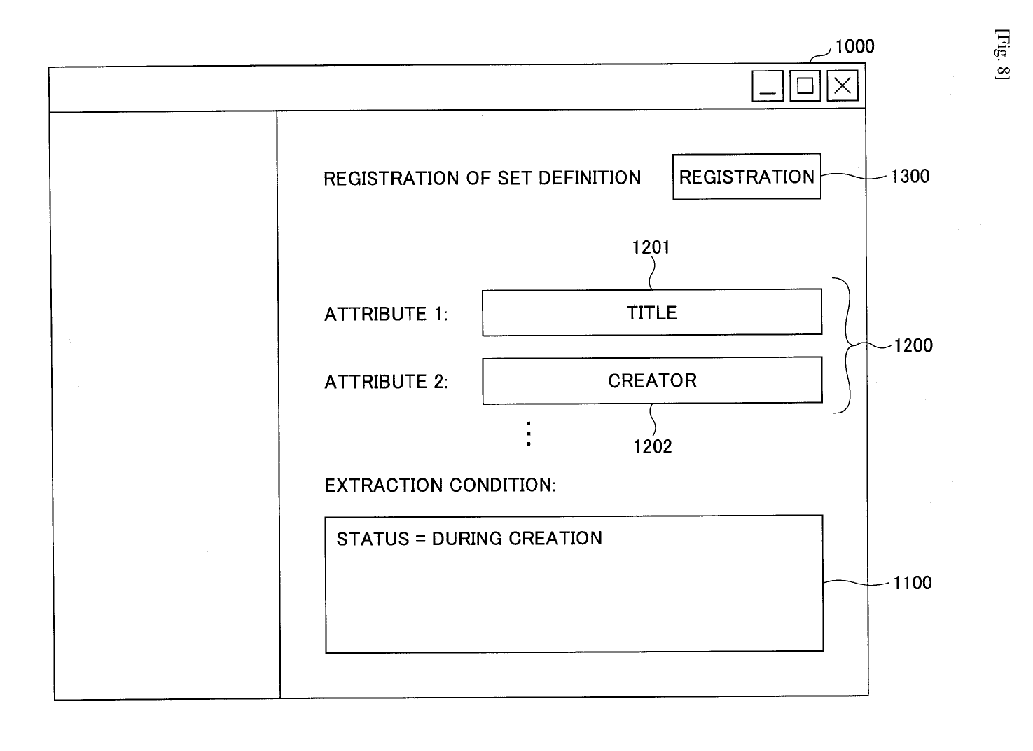

The content set DB 207 manages content set data comprising a content set which is a subset of content. Here, the content set DB 207 will be described in detail with reference to FIGS. 6A to 6C. FIGS. 6A to 6C are diagrams depicting an example of the content set DB.

In the content set DB 207, content set data generated based on the set definition data are managed. That is, the content set DB 207 stores, as illustrated in FIGS. 6A through 6C, content set tables 207A to 207C for storing content set data generated based on the set definition data managed in the set definition DB 206.

The set definition table 207A illustrated in FIG. 6A stores content set data generated based on the set definition data of the set definition ID “P-1”.

The set definition table 207B illustrated in FIG. 6B stores content set data generated based on the set definition data of the set definition ID “P-2”.

The set definition table 207C illustrated in FIG. 6C stores content set data generated based on the set definition data of the set definition ID “P-3”.

As described above, in the content set DB 207 of the retrieval apparatus 20 according to the present embodiment, content set data generated based on the set definition data are stored in a content set table, and managed.

Here, the registration unit 211, the acquisition unit 212, the determination unit 213, the index unit 214 and the set unit 215 will be described in detail.

The registration unit 211, in a registration process for set definition, stores set definition data included into a registration request for set definition to the set definition DB 206. Moreover, the registration unit 211, in a registration process for content, stores content data included in a registration request for content into the content DB 205.

The acquisition unit 212, in the registration process for set definition, acquires content data from the content DB 205, when set definition data are stored in the set definition DB 206. Moreover, the acquisition unit 212, in the registration process for content, acquires set definition data from the set definition DB 206, when the content data is stored in the content DB 205.

The determination unit 213, in the registration process for set definition, determines whether the content data acquired by the acquisition unit 212 satisfies an extraction condition included in the set definition data regarding the registration request. Moreover, the determination unit 213, in the registration process for content, determines whether the content data regarding the registration request satisfies an extraction condition included in the set definition data acquired by the acquisition unit 212.

The index unit 214, in the registration process for set definition, depending on a determination result by the determination unit 213, based on the content data acquired by the acquisition unit 212 and index object attribute included in the set definition data regarding the registration request, generates content set data. Moreover, the index unit 214, in the registration process for content, depending on a determination result by the determination unit 213, based on the content data regarding the registration request and index object attribute included in the set definition data acquired by the acquisition unit 212, generates content set data.

That is, the index unit 214 extracts a data item indicated by the index object attribute from content data that is determined to satisfy the extraction condition by the determination unit 213, and generates content set data. In other words, the index unit 214 indexes content data that are determined to satisfy extraction condition by the determination unit 213 by data items indicated by the index object attribute, and generates content set data.

The set unit 215, in the registration process for set definition, stores the content set data generated by the index unit 214 into a content set table, and stores the content set table in the content set DB 207. Moreover, the set unit 215, in the registration process for content, stores (adds) content set data generated by the index unit 214 into a content set table corresponding to the set definition data acquired by the acquisition unit 212.

<Details of Process>

Next, the process of the retrieval system 1 according to the first embodiment will be described in detail.

At first, a process where a user U₁ defines set definitions and registers them in the retrieval apparatus 20 will be described with reference to FIG. 7. FIG. 7 is a sequence diagram depicting an example of a registration process for set definitions according to the first embodiment. In the following, a case where the user U₁ defines set definitions indicated by set definition data of the set definition ID “P-1” illustrated in FIG. 5, and stores them into the set definition DB 206 of the retrieval apparatus 20 will be described.

At first, the user U₁ performs a display operation in order to display a registration screen for set definitions on the display device 12 of the terminal device 10 (step S701). Then, the input acceptance unit 101 of the terminal device 10 accepts the display operation.

When the input acceptance unit 101 accepts the display operation to display the registration screen for set definitions, the display control unit 105 of the terminal device 10, for example, displays a registration screen 1000 for set definitions illustrated in FIG. 8, for example, on the display device 12 (step S702).

Here, the registration screen 1000 for set definitions illustrated in FIG. 8 is a screen for which the user U₁ defines set definitions and registers them in the retrieval apparatus 20. The registration screen 1000 for set definitions includes an extraction condition configuration field 1100 for setting an extraction condition included in set definition data, and an attribute configuration field 1200 for setting index object attributes. Moreover, the registration screen 1000 of set definitions includes a registration button 1300 for registering set definitions of content set in the extraction condition configuration field 1100 and the attribute configuration field 1200 in the retrieval apparatus 20.

In the registration screen 1000 for set definitions illustrated in FIG. 8, a case where the attribute configuration field 1200 includes an attribute 1 configuration field 1201 and an attribute 2 configuration field 1202 are included is illustrated. However, not limited to this, the attribute configuration field 1200 may include an arbitrary number of attribute configuration fields.

The user U₁, in the registration screen 1000 of set definitions, performs a registration operation for set definition (step S703). That is, the user U₁, in the registration screen 1000 of set definitions, for example, inputs that the extraction condition configuration field 1100 is “status=during creation”. Moreover, the user U₁, inputs that the attribute 1 configuration field 1201 of the attribute configuration field 1200 is “title” and inputs that the attribute 2 configuration field 1202 is “creator”, and holds down the registration button 1300, to perform a registration operation for set definitions. Then, the input acceptance unit 101 of the terminal device 10 accepts the registration operation.

In the extraction condition configuration field 1100, various condition formulas for extracting content data from the content DB 205 can be selected. For example, in the extraction condition configuration field 1100, a condition formula represented by relational algebra or relational logic may be input for a data item of content data. Moreover, for example, in the extraction condition configuration field 1100, SQL may be input.

When the input acceptance unit 101 accepts a registration operation for set definition, the registration request unit 102 of the terminal device 10 sends a registration request for set definition including set definition data to the retrieval apparatus 20 (step S704). Here, the set definition data include an extraction condition set by the user U₁ in the registration screen 1000 for set definition, an index object attribute, and set definition ID generated by the registration request unit 102.

The registration processing unit 201 of the retrieval apparatus 20, when receiving a registration request for set definition, stores set definition data included in the registration request into the set definition DB 206 by the registration unit 211 (step S705). Accordingly, the set definition defined by the user U₁ is registered in the retrieval apparatus 20.

Next, the registration processing unit 201 of the retrieval apparatus 20 performs a generation process for content set (step S706). That is, the registration processing unit 201 generates a content set based on the registered set definition. The generation process for content set will be described later in detail.

Subsequently, the registration processing unit 201 of the retrieval apparatus 20, when generating content set, sends a registration result indicating that the set definition is registered to the terminal device 10 (step S707).

Finally, the display control unit 105 of the terminal device 10 displays a registration result screen indicating that the set definition is registered on the display device 12 (step S708).

As described above, in the retrieval system 1 according to the embodiment, set definition defined by the user U₁ can be registered in the retrieval apparatus 20.

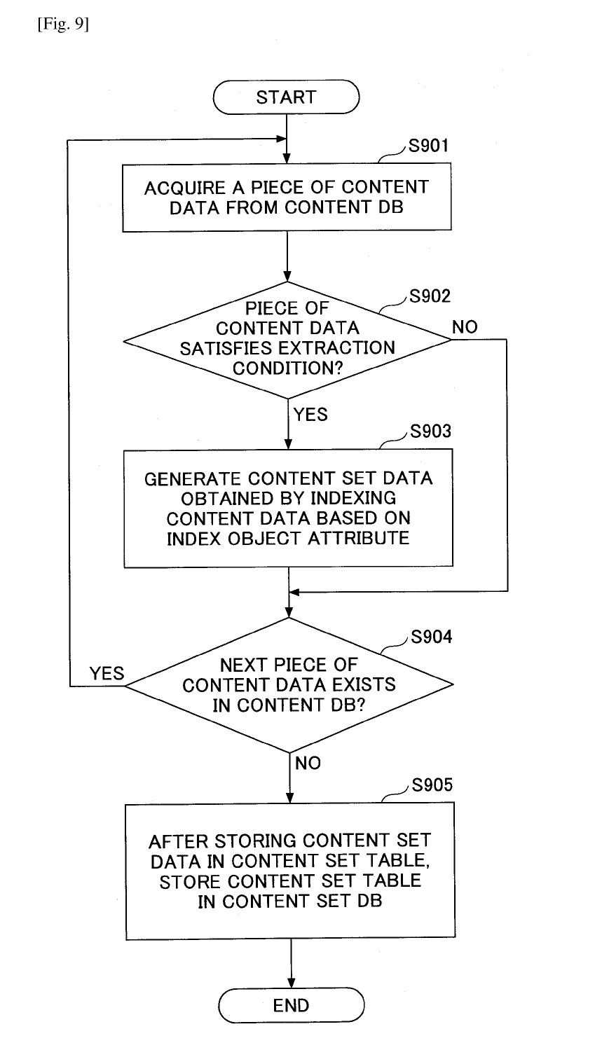

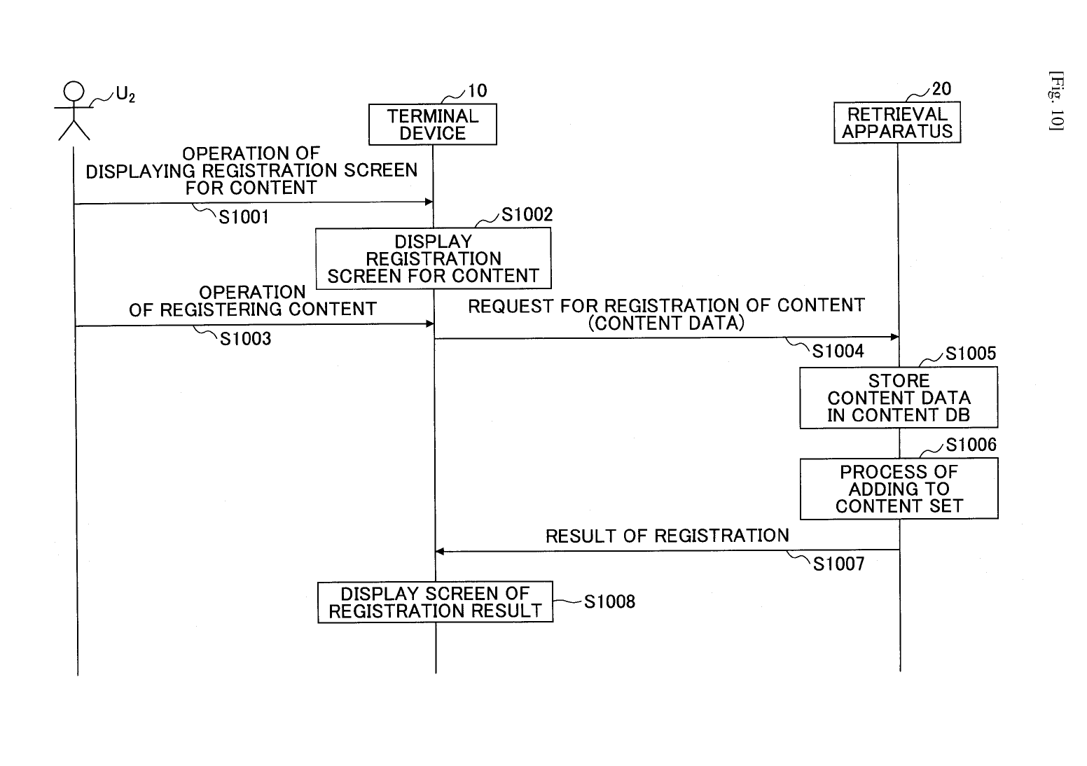

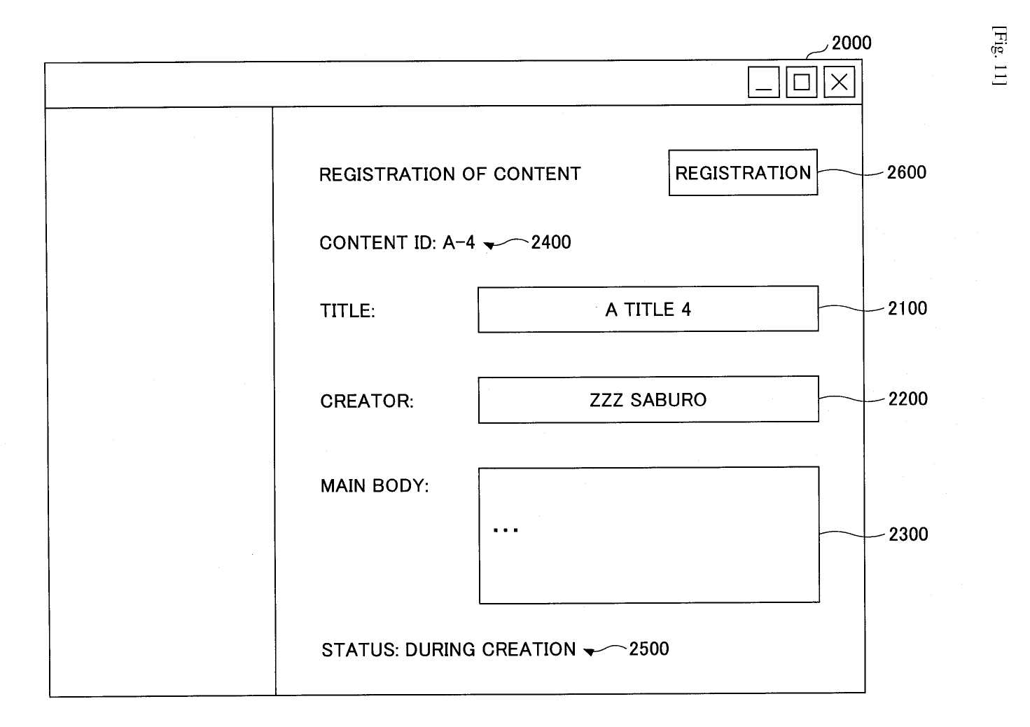

Next, the generation process for content set in step S706 will be described in detail with reference to FIG. 9. FIG. 9 is a flowchart depicting an example of generation process for content set according to the first embodiment.

At first, the acquisition unit 212 of the registration processing unit 201 acquires a piece of content data from the content DB 205 (step S901).

Next, the determination unit 213 of the registration processing unit 201, when content data are acquired by the acquisition unit 212, determines whether the content data satisfy the extraction condition for set definition data registered by the registration unit 211 at step S705 in FIG. 7 (step S902).

For example, when the extraction condition for set definition data is “status=during creation”, the determination unit 213 determines whether the content data acquired by the acquisition unit 212 has a data item “status” and a value of the data item is “during creation”.

When the determination unit 213 determines that the extraction condition is satisfied at step S902, the index unit 214, based on the content data and index object attribute included in the set definition data, generates content set data (step S903).

That is, the index unit 214 indexes the content data with the data item indicated by the index object attribute, to generate content set data. At this time, when the content data do not have at least one data item of the data items indicated by the index object attribute, for a value of the data item, for example a blank, a null value or the like is entered.

More specifically, when the index object attribute is “title” and “creator”, the index unit 214 extracts data items of “content ID”, “title” and “creator” from the content data, and generates content set data. At this time, the index unit 214, when the content data do not have data item of “title”, for example, leaves a blank, a null value or the like for the data item of “title”, to generate content set data. Similarly, the index unit 214, when the content data do not have data item of “creator”, for example, leaves a blank, a null value or the like for the data item of “creator”, to generate content set data.

When the determination unit 213 determines that the extraction condition is not satisfied at step S902, the registration processing unit 201 proceeds to step S904.

Subsequently, the acquisition unit 212 of the registration processing unit 201 determines whether next content data exist in the content DB 205 (step S904).

When the acquisition unit 212 determines that next content data exist in the content DB 205 at step S904, the registration processing unit 201 returns to step S901. That is, the registration processing unit 201 performs processing at steps S901 through S904 for all content data stored in the content DB 205.

When the acquisition unit 212 determines that next content data do not exist in the content DB 205 at step S904, the set unit 215 generates a content set table associated with the set definition ID included in the set definition data. Then, the set unit 215 stores the content set data generated by the index unit 214 at step S905 in the content set table, and stores the content set table in the content set DB 207 (step S905).

More specifically, when the set definition ID included in set definition data is “P-1”, the set unit 215 creates content set table, set definition ID of which is “P-1”. Then, the set unit 215 stores content set data created by the index unit 214 in the content set table, and stores the content set table into content set DB 207. Therefore, content set corresponding to set definition registered by the user U₁ is generated and registered.

As described above, in the retrieval system 1 according to the embodiment, based on the set definition registered by the user U₁, content set is generated and registered in the retrieval apparatus 20. Furthermore, in the retrieval system 1 according to the embodiment, an extraction condition and an index object attribute are defined in set definition. Therefore, in the retrieval system 1 according to the embodiment, a content set can be generated and registered as an index that can be commonly used for content data having various data structures.

Moreover, in the retrieval system 1 according to the embodiment, the user U₁ can register a set definition in order to generate a set of content provided for specific purpose. That is, the user U₁ can generate content set that is provided for specific purpose and indexed by defining an extraction condition or an index object attribute.

For example, by registering set definition that defines an extraction condition is “status=processed for approval”, an index of a set of content that is processed for approval can be generated. Similarly, for example, by registering set definition that defines an extraction condition is “creation data>=May 1, 2015 and creation date<=May 31, 2015”, an index of a set of content that is created in May can be generated.

When there is not a data item defined as an extraction condition at step S902 in the generation process for content set according to the embodiment, the determination unit 213 may determine whether the extraction condition is satisfied with a value of a data item similar to the data item or a data item corresponding to subordinate concept.

For example, assume that the extraction condition for set definition data is “creator=XXX Taro”, and data items of content data acquired by the acquisition unit 212 are “content ID”, “category”, “writing person”, “management organization”, and “description content”. In this case, the content data do not include the data item “creator”, whereas the content data include a data item “writing person” similar to the data item. Therefore, the determination unit 213 may determine whether a value of the data item “writing person” is “XXX Taro”.

Similarly, for example, assume that the extraction condition for set definition data is “user=XXX Taro”, and data items of content data acquired by the acquisition unit 212 are “content ID”, “category”, “writing person”, “management organization”, and “description content”. In this case, the content data do not include data item “user”, whereas the data items include a data item “writing person” corresponding to the subordinate concept. Therefore, the determination unit 213 may determine whether a value of the data item “writing person” is “XXX Taro”.

In this way, the determination unit 213 may determine whether content data including a data item similar to a data item defined as an extraction condition for set definition data, a data item corresponding subordinate concept or the like satisfy the extraction condition.

Next, a process of registering content in the retrieval apparatus 20 by a user U₂ will be described with reference to FIG. 10. FIG. 10 is a sequence diagram depicting an example of a registration process for content according to the first embodiment. The user U₂ is distinguished from the user U₁ who registers set definition.

For example, the user U₁ is a user who defines an operating process or the like in which content of retrieval object is created, whereas the user U₂ is a user who performs creation of content, retrieval of content or the like according to the operating process defined by the user U₁. In this way, in the retrieval system 1 according to the embodiment, a case where the user U₁ who registers set definition and the user U₂ who performs registration, retrieval or the like of content are different from each other is assumed. However, not limited to this, the user U₁ and the user U₂ may be the same user.

At first, the user U₂ performs a display operation in order to display a registration screen for content on the display device 12 of the terminal device 10 (step S1001). Then, the input acceptance unit 101 of the terminal device 10 accepts the display operation.

When the input acceptance unit 101 accepts the display operation for displaying the registration screen for content, the display control unit 105 of the terminal device 10 displays a registration screen 2000 for content illustrated in FIG. 11, for example, on the display device 12 (step S1002).

Here, the registration screen 2000 for content illustrated in FIG. 11 is a screen for registering content that the user U₂ creates in the retrieval apparatus 20. In the example illustrated in FIG. 11, the content registration screen 2000 for registering content illustrated by content data including “content ID”, “title”, “creator”, “status”, and “main body”, as data items, in the retrieval apparatus 20.

The content registration screen 2000 includes a title configuration field 2100 for configuring a value of data item “title”, a creator configuration field 2200 for configuring a value of data item “creator”, and a main body configuration field 2300 for configuring a value of data item “main body”. The user U₂ edits in the configuration fields 2100 through 2300, and thereby edits values of the respective data items of content data.

Moreover, the content registration screen 2000 includes a content ID 2400 indicating a value of the data item “content ID” and a status 2500 indicating a status of content. The content ID 2400 and the status 2500 are configured, for example, by the terminal program 30. The user U₂ may modify the content ID 2400 and the status 2500.

The user U₂ performs registration operation for content on the content registration screen 2000 (step S1003). Then, the input acceptance unit 101 of the terminal device 10 accepts the registration operation. That is, the user U₂, in the content registration screen 2000, edits the configuration fields 2100 through 2300 as necessary, and holds down the registration button 2600 for registering content in the retrieval apparatus 20.

When the input acceptance unit 101 accepts the registration operation for content, the registration request unit 102 of the terminal device 10 sends a registration request for content to the retrieval apparatus 20 (step S1004). Here, the registration request includes content data indicating content created by the user U₂.

The registration processing unit 201 of the retrieval apparatus 20, when receiving the registration request for content, by the registration unit 211, stores content data included in the registration request into the content DB 205 (step S1005). Therefore, the content created by the user U₂ is registered in the retrieval apparatus 20.

Next, the registration processing unit 201 of the retrieval apparatus 20 performs an addition process to content set (step S1006). That is, the registration processing unit 201, based on the registered content and set definition data stored in the set definition DB 206, add the content to content set. The addition process to content set will be described later in detail.

Subsequently, when the registered content is added to the content set, the registration processing unit 201 of the retrieval apparatus 20 sends a registration result indicating that the content is registered to the terminal device 10 (step S1007).

Finally, the display control unit 105 of the terminal apparatus 10 displays a registration result screen indicating that the content is registered on the display device 12 (step S1008).

As described above, in the retrieval system 1 according to the embodiment, content created by the user U₂ can be registered in the retrieval apparatus 20.

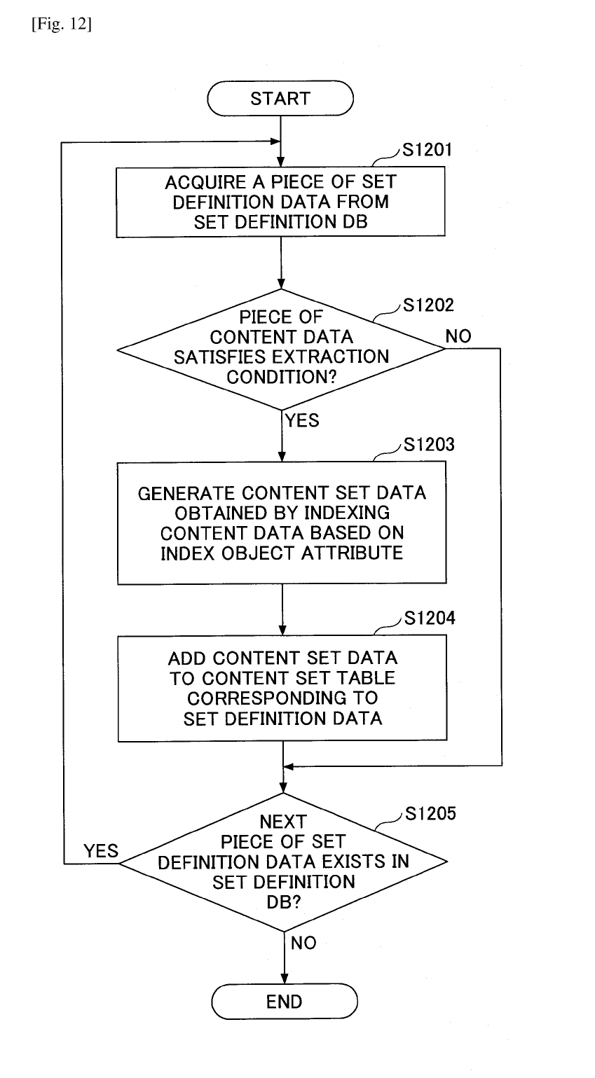

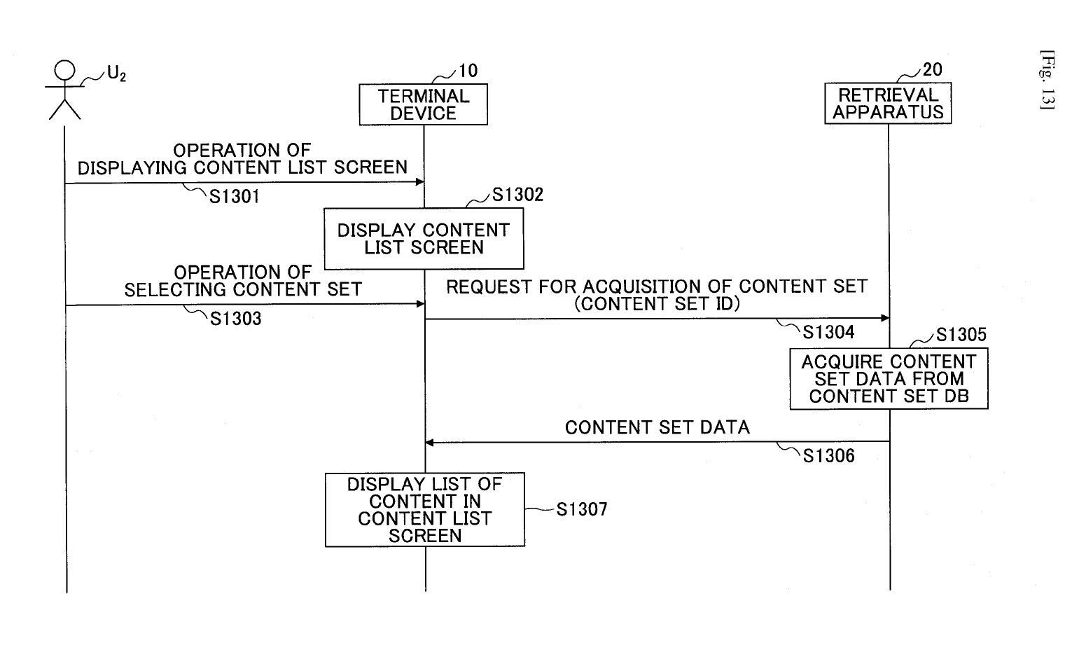

Next, the addition process to content set at step S1006 will be described in detail with reference to FIG. 12. FIG. 12 is a flowchart depicting an example of the addition process to content set according to the first embodiment.

At first, the acquisition unit 212 of the registration processing unit 201 acquires a piece of set definition data from the set definition DB 206 (step S1201).

Next, when the set definition data is acquired by the acquisition unit 212, the determination unit 213 of the registration processing unit 201 determines whether the content data registered by the registration unit 211 at step S1005 in FIG. 10 satisfies an extraction condition of the set definition data (step S1202).

When the determination unit 213 determines that the extraction condition is not satisfied at step S1002, the registration processing unit 201 proceeds to step S1205.

When the determination unit 213 determines that the extraction condition is satisfied at step S1002, the index unit 214 generates content set data based on the content data and an index object attribute included in the set definition data (step S1203). That is, the index unit 214 performs the same processing as step S903 in FIG. 9.

Next, the set unit 215 adds content set data to a content set table which is a content set table stored in the content set DB 207 and corresponds to a set definition ID of the set definition data acquired by the acquisition unit 212 (step S1204). Therefore, the content set data based on the registered content are added to the content set table corresponding to the set definition that satisfies the extraction condition.

Finally, the acquisition unit 212 of the registration processing unit 201 determines whether next set definition data exist in the set definition DB 206 (step S1205).

When the acquisition unit 212 determines that next set definition data exist in the set definition DB 206 at step S1205, the registration processing unit 201 returns to step S1201. That is, the registration processing unit 201 performs the processing at steps S1201 through S1205 for all set definition data stored in the set definition DB 206.

When the acquisition unit 212 determines that next set definition data do not exist in the set definition DB 206 at step S1205, the registration processing unit 201 ends the processing.

As described above, in the retrieval system 1 according to the embodiment, the content created by the user U₂ is registered in the retrieval apparatus 20. Moreover, at this time, in the retrieval system 1 according to the embodiment, depending on set definition corresponding to the content set registered in the retrieval apparatus 20, content is added to the content set.

In this way, in the retrieval system 1 according to the embodiment, when new content is created by the user U₂, the content is added to the content set that has already been registered. Therefore, in the retrieval system 1 according to the embodiment, in response to registration of new content, an index for retrieving the registered content (i.e. content set) can be created dynamically.

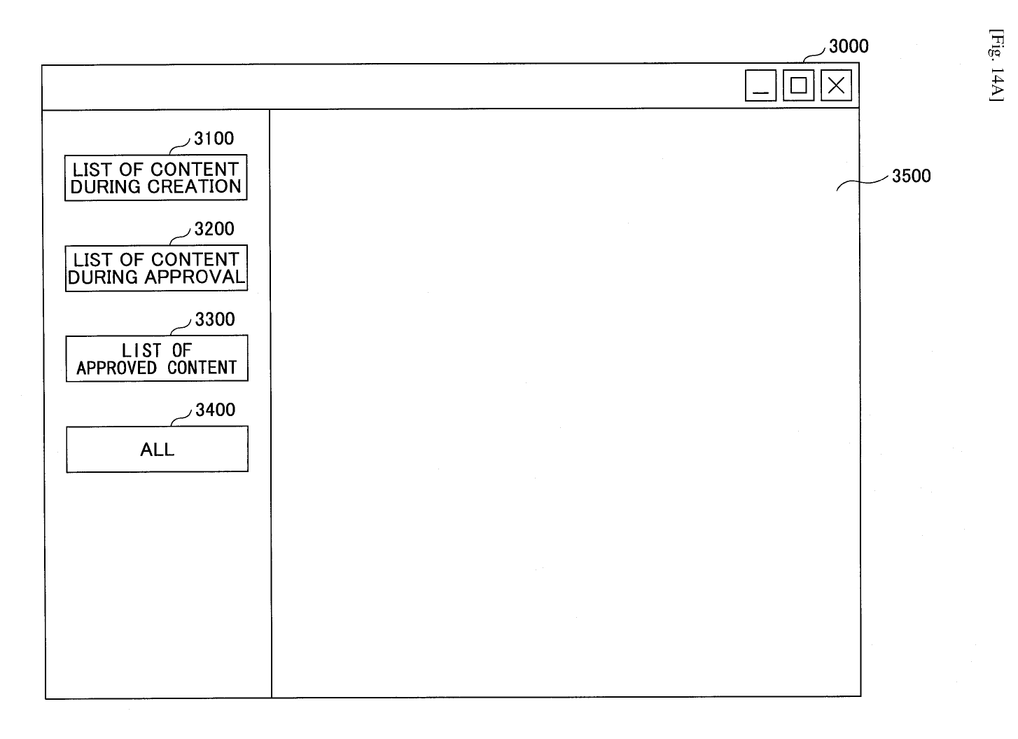

Next, the process of displaying by the user U₂ a content list that is indexed as content set on the display device 12 of the terminal device 10 will be described with reference to FIG. 13. FIG. 13 is a sequence diagram depicting an example of the display process for content set according to the first embodiment.

At first, the user U₂ performs a display operation for displaying a content list screen on the display device 12 of the terminal device 10 (step S1301). Then, the input acceptance unit 101 of the terminal device 10 accepts the display operation.

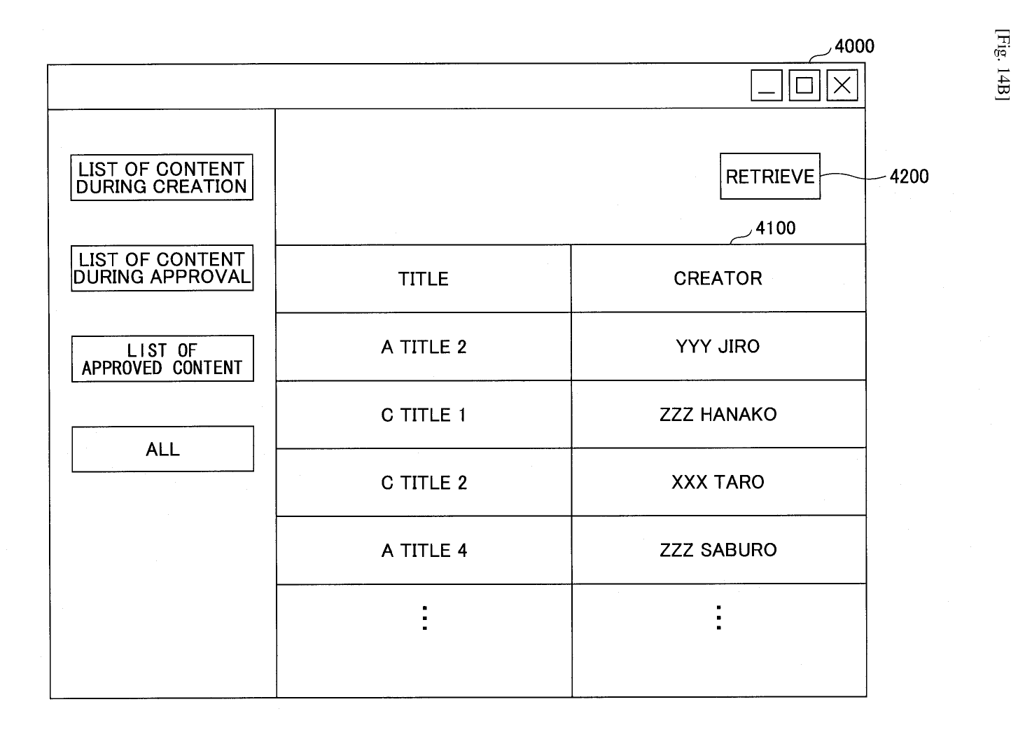

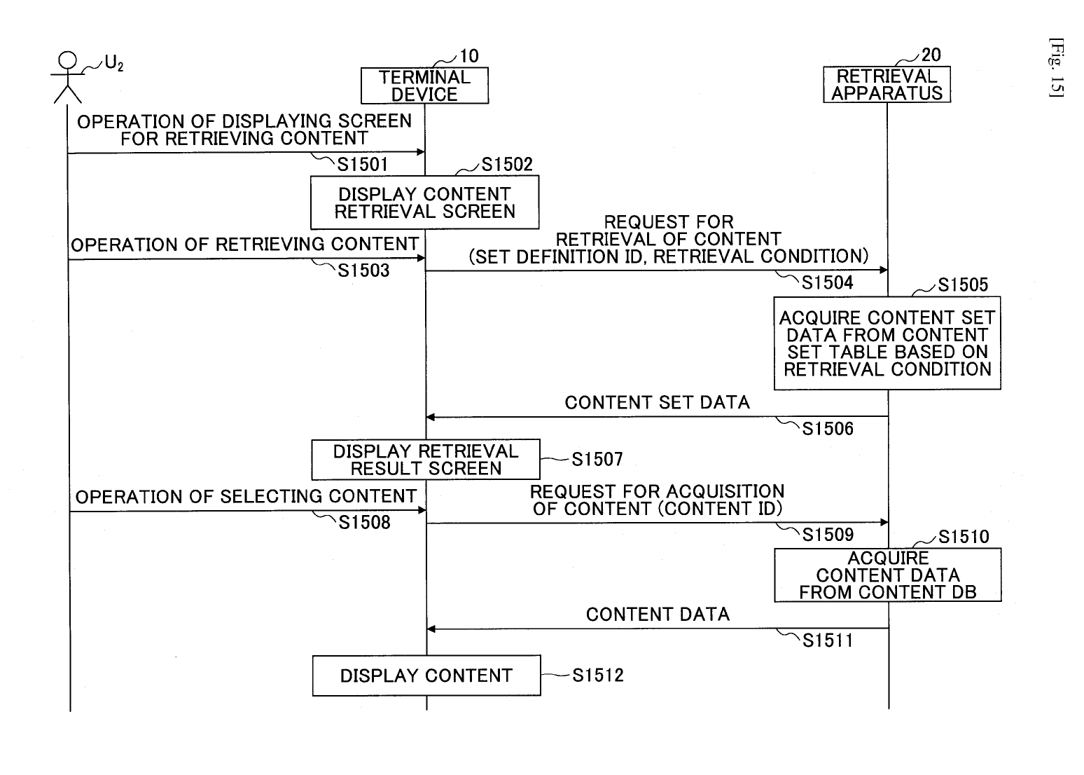

When the input acceptance unit 101 accepts the display operation for displaying a content list screen, the display control unit 105 of the terminal device 10 displays a content list screen 3000, as illustrated in FIG. 14A, for example, on the display device 12 (step S1302).

Here, the content list screen 3000 illustrated in FIG. 14A is a screen for displaying a list of content registered as content set. The content list screen 3000 includes a list of content during creation button 3100, a list of content during approval button 3200, a list of approved content button 3300 and an all button 3400.

For example, the list of content during creation button 3100 is an icon for displaying content set corresponding to the set definition ID “P-1”. Moreover, for example, the list of approved content button 3300 is an icon for displaying set definition of the set definition ID “P-3”.

In this way, the content list screen 3000 includes a display component such as an icon associated with the set definition ID of the set definition registered in the retrieval apparatus 20. The user U₂ selects a desired display component in the content list screen 3000, and thereby displays content set corresponding to the display component in a content display region 3500.

The all button 3400 is not associated with the set definition ID. The all button 3400 is an icon for displaying a list of all contents registered in the retrieval apparatus 20 in the content display region 3500.

The user U₂ performs a selection operation for content set in the content list screen 3000 (step S1303). That is, the user U₂ performs an operation of selecting any one of the list of content during creation button 3100, the list of content during approval button 3200, the list of approved content button 3300 and the all button 3400 in the content list screen 3000. Then, the input acceptance unit 101 of the terminal device 10 accepts the selection operation. In the following, an explanation will be provided assuming that the user U₂ select the list of content during creation button 3100 is selected in the content list screen 3000.

When the input acceptance unit 101 accepts the selection operation for content set, the acquisition request unit 103 of the terminal device 10 sends an acquisition request for content set to the retrieval apparatus 20 (step S1304). Here, the acquisition request includes a set definition ID associated with the display component selected by the user U₂. That is, the acquisition request includes the set definition ID “P-1” associated with the list of content during creation button 3100 selected by the user U₂.

The set acquisition processing unit 202 of the retrieval apparatus 20, when receiving the acquisition request for content set, acquires a content set table associated with a set definition ID included in the acquisition request from the content set DB 207 (step S1305). That is, the set acquisition processing unit 202 acquires a content set table associated with the set definition ID “P-1” from the content set DB 207.

Next, the set acquisition processing unit 202 of the retrieval apparatus 20 sends content set data stored in the acquired content set table to the terminal device 10 (step S1306).

The display control unit 105 of the terminal device 10, when receiving the content set data from the retrieval apparatus 20, based on the content set data, displays a content list screen 4000, as illustrated in FIG. 14B, for example, on the display device 12 (step S1307). That is, the display control unit 105 displays a list of content based on the received content set data in a content display region 4100 of the content list screen 4000. Therefore, content set corresponding to the set definition ID “P-1” is displayed.

In the content list screen 4000 illustrated in FIG. 14B, the user U₂ holds down a retrieval button 4200, and thereby retrieves target content in content set displayed in the content display region 4100.

As described above, in the retrieval system 1 according to the embodiment, a list of content included in the content set selected by the user U₂ can be displayed.

In the retrieval system 1 according to the embodiment, the retrieval apparatus 20 is assumed to send, in response to the acquisition request for content set from a terminal device 10, content set data to the terminal device 10, but not limited to this. That is, the retrieval apparatus 20 may return content data corresponding to the content set data to the terminal device 10. Therefore, in the terminal device 10, a data item, which is included in the content data but is not the data item indicated by the index object attribute, can also be displayed as a list.

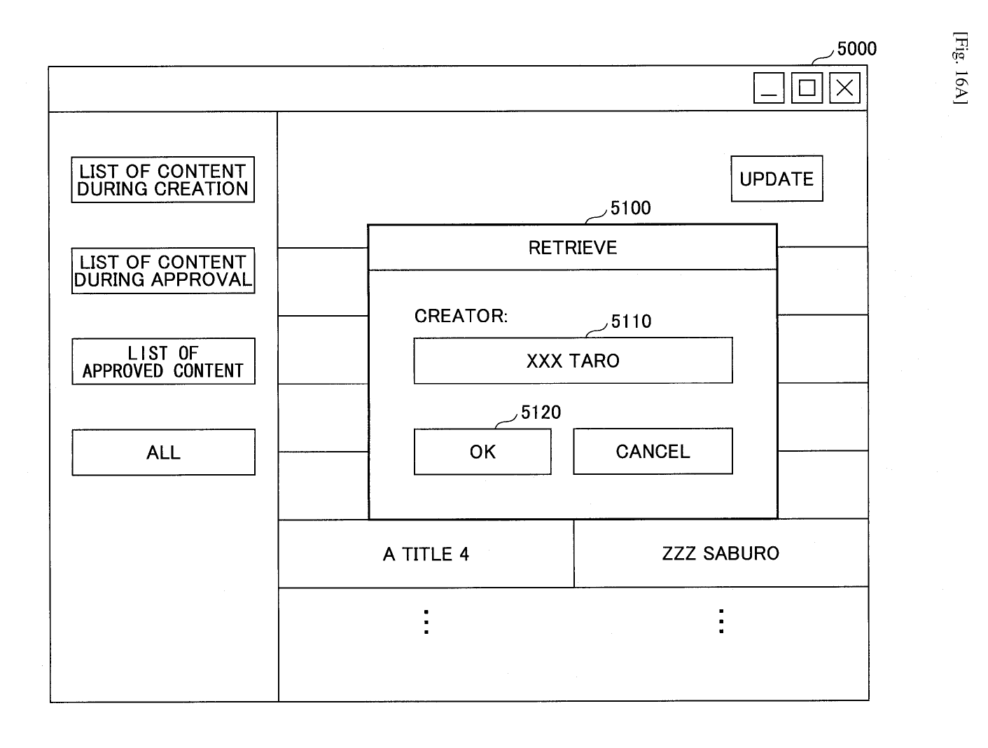

Next, a process where the user U₂ holds down the retrieval button 4200 in the content list screen 4000 to retrieve target content in the content set will be described with reference to FIG. 15. FIG. 15 is a sequence diagram depicting an example of a retrieval process for content according to the first embodiment.

At first, the user U₂ performs a display operation for displaying a retrieval screen for content on the display device 12 of the terminal device 10 (step S1501). Then, the input acceptance unit 101 of the terminal device 10 accepts the display operation.

When the input acceptance unit 101 accepts the display operation for displaying a retrieval screen for content, the display control unit 105 of the terminal device 10 displays a retrieval screen for content 500, as illustrated in FIG. 15A, for example, on the display device 12 (step S1502).

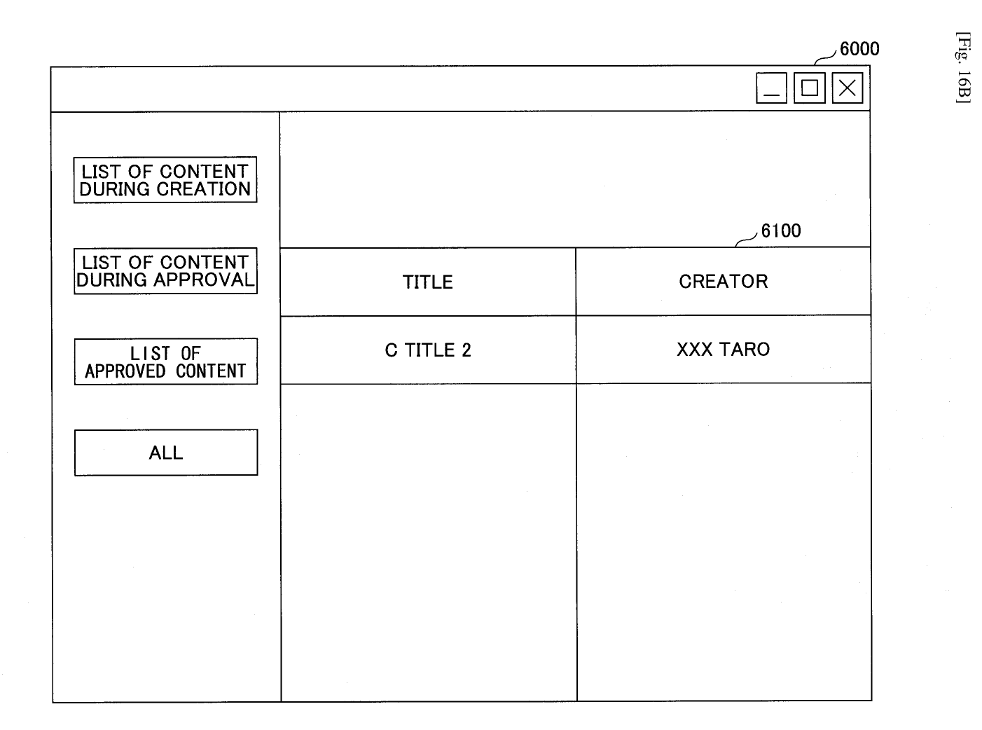

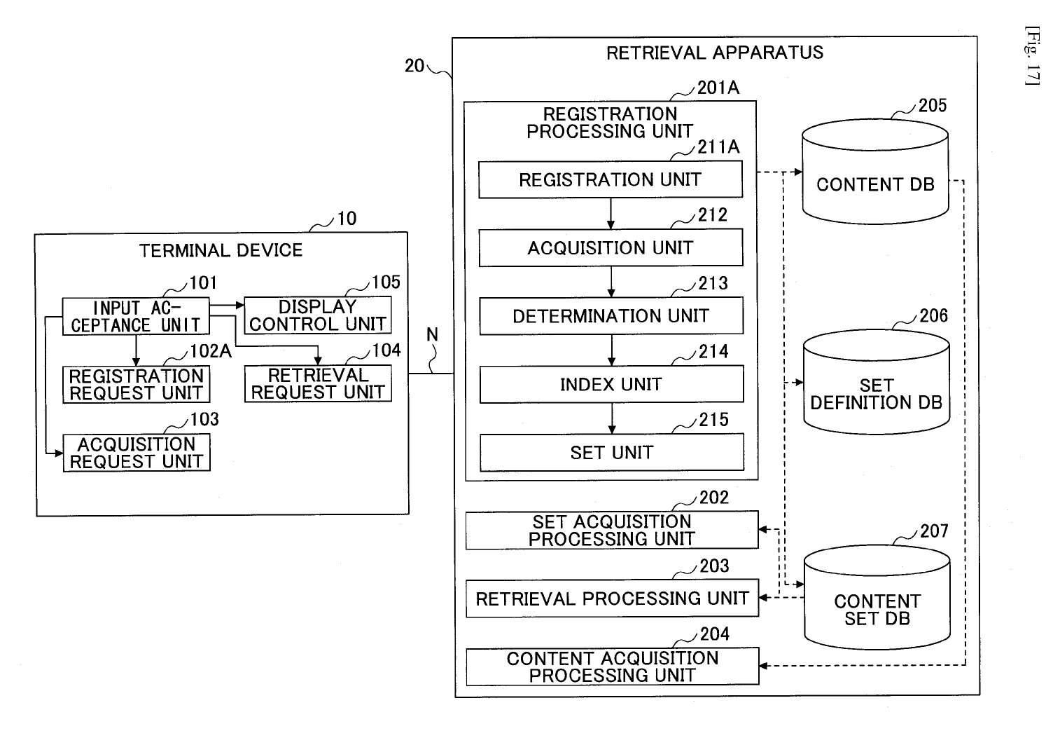

Here, the retrieval screen 5000 for content illustrated in FIG. 16A is a screen in which the user U₂ retrieves desired content from content set corresponding to the set definition ID “P-1”. The retrieval screen 5000 for content includes a retrieval window 5100. Moreover, the retrieval window includes a retrieval condition field 5110 for inputting a retrieval condition for the data item “creator” and an OK button 5120 for starting retrieval.

In this way, the retrieval screen for content 5000 includes the retrieval condition field 5110 to which the user U₂ input a retrieval condition. The user U₂ inputs a retrieval condition for retrieving desired content in the retrieval condition field 5110, and holds down the OK button 5120, and thereby retrieves the desired content from the content set.

In FIG. 16A, the retrieval window 5100 is assumed to include the retrieval condition field 5110 for inputting a retrieval value for a data item “creator”, but not limited to this. The retrieval window 5100 may include a retrieval condition field for inputting a retrieval condition for a data item “title”. That is, the retrieval window 5100 may include a retrieval condition field for inputting a retrieval condition for respective data items of content set data configuring content set of a retrieval object.

The user U₂ performs a retrieval operation for content in the retrieval screen for content 5000 (step S1503). That is, the user U₂ inputs a retrieval condition in the retrieval condition field 5110 in the retrieval window 5100 of the retrieval screen for content 5000 and holds down the OK button 5120, to perform the retrieval operation. Then, the input acceptance unit 101 of the terminal device 10 accepts the retrieval operation. In the following, an explanation will be provided assuming that the user U₂ inputs “XXX Taro” in the retrieval condition field 5110 and holds down the OK button 5120.

When the input acceptance unit 101 accepts the retrieval operation for content, the retrieval request unit 104 of the terminal device 10 sends a retrieval request for content to the retrieval apparatus 20 (step S1504). Here, the retrieval request includes a set definition ID of content set that is the retrieval object and a retrieval condition input to the retrieval condition field 5110 by the user U₂. More specifically, the retrieval request includes the set definition ID “P-1” and the retrieval condition “creator=XXX Taro”.

The retrieval processing unit 203 of the retrieval apparatus 20, when receiving the retrieval request for content, acquires content set data that satisfies the retrieval condition in a content set table of the set definition ID included in the retrieval request (step S1505).

More specifically, the retrieval processing unit 203 acquires content set data in which the data item “creator” is “XXX Taro” in content set table of the set definition ID “P-1”.

Next, the retrieval processing unit 203 of the retrieval apparatus 20 sends the acquired content set data to the terminal device 10 (step S1506).

The display control unit 105 of the terminal device 10, when receiving the content set data from the retrieval apparatus 20, based on the content set data, displays, for example, a retrieval result screen 6000 illustrated in FIG. 16B on the display device 12 (step S1507). That is, the display control device 105 displays a list of content based on the received content set data in a retrieval result display region 6100 in the retrieval result screen 6000. Therefore, content that satisfies the condition “Creator=XXX Taro” specified by the user U₂ in the content set of the set definition ID “P-1”.

Next, a case where the user U₂ selects desired content from the list of content displayed as a retrieval result, and displays substance of the content will be described.

The user U₂ performs a selection operation for content in the retrieval result screen 6000 (step S1508). That is, the user U₂ performs a selection operation for selecting desired content from the list of content displayed in the retrieval result display region 6100 of the retrieval result screen 6000. Then, the input acceptance unit 101 of the terminal device 10 accepts the selection operation.

When the input acceptance unit 101 accepts the selection operation for content, the acquisition request unit 103 of the terminal device 10 sends an acquisition request for content to the retrieval apparatus 20 (step S1509). Here, the acquisition request includes a content ID of content selected from the list of content by the user U₂.

The content acquisition unit 204 of the retrieval apparatus 20, when receiving the acquisition request for content, acquires content data of the content ID included in the acquisition request from the content DB 205 (step S1510).

Next, the content acquisition processing unit 204 of the retrieval apparatus 20 sends the acquired content data to the terminal device 10 (step S1511).

The display control unit of the terminal device 10, when receiving the content data from the retrieval apparatus 20, displays content indicated by the content data on the display device 12 (step S1512). Therefore, the content selected by the user U₂ in the retrieval result screen 6000 is displayed.

As described above, in the retrieval system 1 according to the embodiment, retrieval for content under a retrieval condition specified by a user U₂ can be performed in a content set specified by the user U₂. In this way, because in the retrieval system 1 according to the embodiment the retrieval for content is performed in the content set specified by the user U₂, retrieval result can be obtained sooner than the retrieval in the content DB 205.

### Second Embodiment

Next, a retrieval system 1 according to a second embodiment will be described. In the description of the second embodiment, a difference from the first embodiment will be described, the same reference numeral is assigned to a member that has the same functional configuration as the first embodiment, and an explanation thereof will be omitted.

In the embodiment, a user U₁ of a terminal device 10 can change (update) set definition registered in a retrieval apparatus 20.

<Functional Configuration>

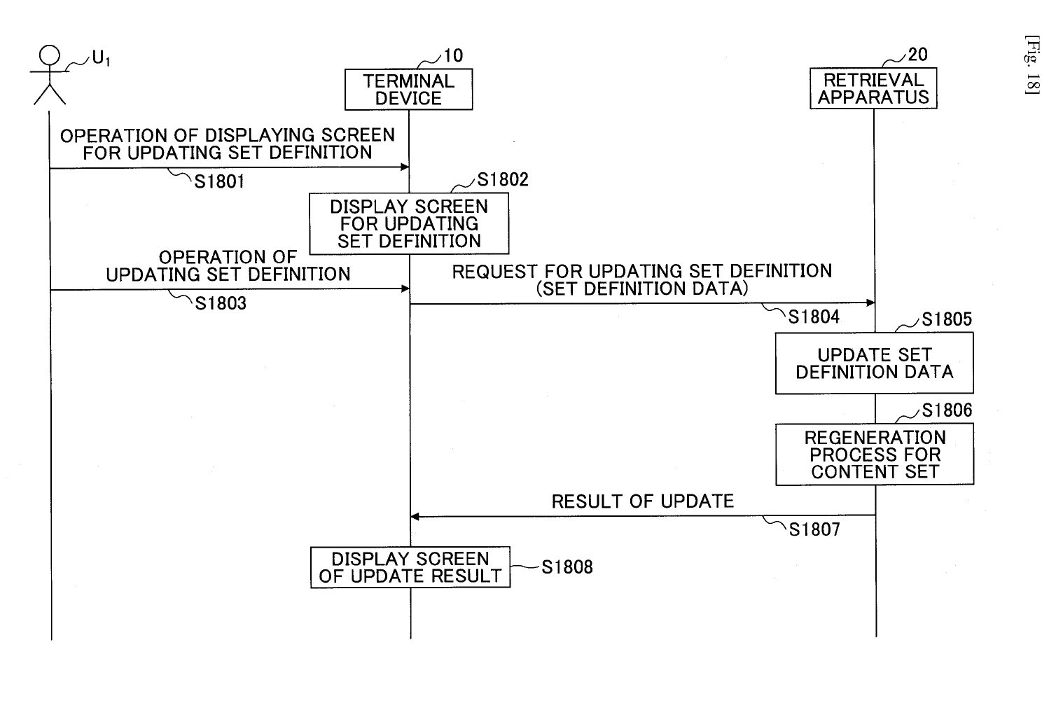

Functional configuration of the retrieval system 1 according to the second embodiment will be described with reference to FIG. 17. FIG. 17 is a diagram depicting an example functional configuration of the retrieval system according to the second embodiment.

The terminal device 10 illustrated in FIG. 17 includes a registration request unit 102A. The registration request unit 102A, in response to an input operation accepted by an input acceptance unit 101, sends an update request for set definition to the retrieval apparatus 20.

A registration processing unit 201A of the retrieval apparatus 20 includes a registration unit 211A. The registration unit 211A updates, in an update process for set definition, the set definition data that are set definition data included in the update request for set definition and stored in a set definition DB 206.

<Details of Process>

Next, details of the process of the retrieval system 1 according to the second embodiment will be described.

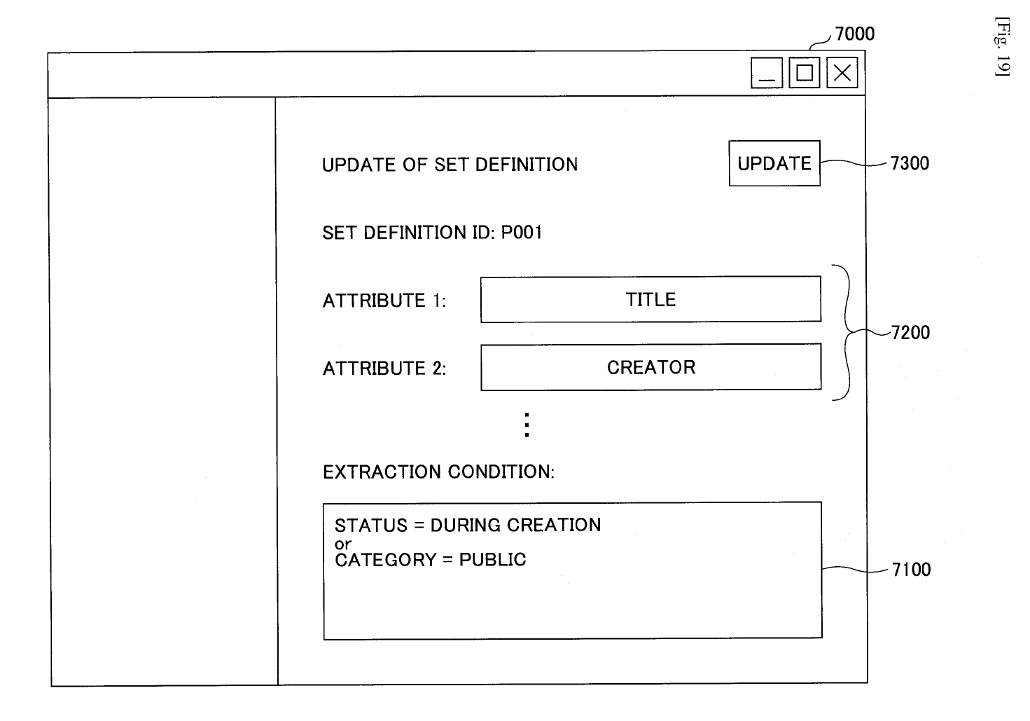

In the following, a process of changing (updating) the set definition registered in the retrieval apparatus 20 by the user U₁ will be described with reference to FIG. 18. FIG. 18 is a sequence diagram depicting an example of the update process for set definition according to the second embodiment.

At first, the user U₁ performs a display operation for displaying an update screen for set definitions on a display device 12 of the terminal device 10 (step S1801). Then, the input acceptance unit 101 of the terminal device 10 accepts the display operation. Here, the user U₁ is assumed to perform a display operation for an update screen for updating set definition of a set definition ID “P-1”.

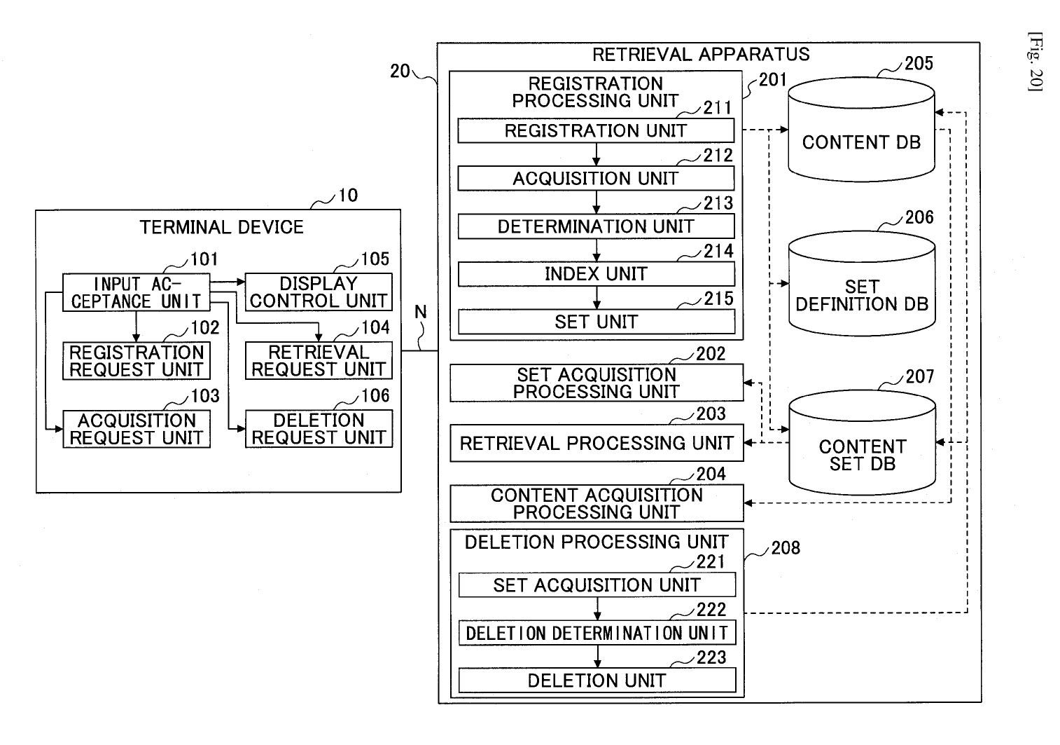

When the acceptance unit 101 accepts the display operation for displaying the update screen for set definition, displays an update screen for set definitions 7000, for example, illustrated in FIG. 19 on the display device 12 (step S1802).

Here, the update screen for set definitions 7000 illustrated in FIG. 19 is a screen for the user U₁ to update definition of set definition registered in the retrieval apparatus 20. The update screen for set definitions 7000 includes an extraction condition change field 7100 for changing an extraction condition for set definition data of set definition ID “P-1” registered in the retrieval apparatus 20, and an attribute change field 7200 for changing index object attribute of the set definition data. Moreover, the update screen for set definitions 7000 includes an update button 7300 for updating corresponding set definition registered in the retrieval apparatus 20 with content changed in the extraction condition change field 7100 and the attribute change field 7200.

The user U₁ performs an update operation for set definition in the update screen for set definitions 7000 (step S1803). That is, the user U₁, in the update screen for set definitions 7000, changes, for example, the extraction condition change field 7100 to “status=during creation or category=public”, and holds down the update button 7300, to perform the update operation for set definition. Then, the input acceptance unit 101 of the terminal device 10 accepts the update operation.

When the input acceptance unit 101 accepts the update operation for set definition, the registration request unit 102A of the terminal device 10 sends an update request for set definition including set definition data to the retrieval apparatus 20 (step S1804). Here, the set definition data include a set definition ID, and an extraction condition or an index object attribute changed by the user U₁.

The registration processing unit 201A of the retrieval apparatus 20, when receiving the update request for set definition, by the registration unit 211A, updates the set definition data included in the update request that are corresponding set definition data stored in the set definition DB 206 (step S1805). That is, when the set definition data are set definition data of the set definition ID “P-1” included in the update request, the registration unit 211A updates (overwrites) the set definition data of the set definition ID “P-1” stored in the set definition DB 206 by the set definition data included in the update request. Therefore, set definition registered in the retrieval apparatus 20 is updated.

Next, the registration processing unit 201A of the retrieval apparatus 20 performs a regeneration process for content set (step S1806). That is, the registration processing unit 201A, deletes a content set table corresponding to the set definition ID of the updated set definition data, and generates a new content set table based on the updated set definition data. Because the process of generating a new content set table based on the updated set definition data is the same as the generation process for content set explained with reference to FIG. 9, an explanation thereof will be omitted.

Subsequently, the registration processing unit 201A of the retrieval apparatus 20, when generating content set, sends an update result indicating that the set definition is updated to the terminal device 10 (step S1807).

Finally, the display control unit 105 of the terminal device 10 displays an update result screen indicating that the set definition is updated on the display device 12 (step S1808).

As described above, in the retrieval system 1 of the embodiment, by the user U₁, set definition registered in the retrieval apparatus 20 is updated. Moreover, at this time, in the retrieval apparatus 20, when set definition is updated, content set is regenerated based on set definition after the update. Therefore, the user U₁, according to a change or the like of purpose of content set, can change set definition corresponding to the content set, as needed.

### Third Embodiment

Next, a retrieval system 1 according to a third embodiment will be described. In the description of the third embodiment, a difference from the first embodiment will be described, the same reference numeral is assigned to a member that has the same functional configuration as the first embodiment, and an explanation thereof will be omitted.

In the embodiment, a user U₂ of a terminal device 10 can delete content registered in a retrieval apparatus 20.

<Functional Configuration>

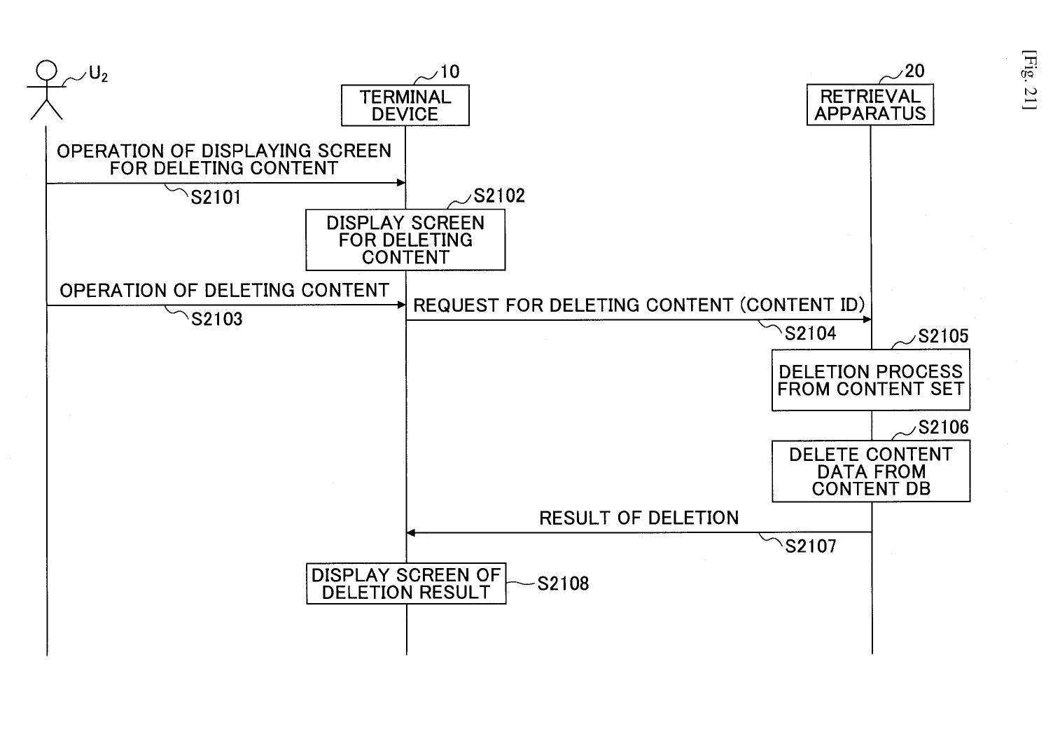

Functional configuration of the retrieval system 1 according to the third embodiment will be described with reference to FIG. 20. FIG. 20 is a diagram depicting an example functional configuration of the retrieval system according to the third embodiment.

The terminal device 10 illustrated in FIG. 20 includes a deletion request unit 106. The function unit is enabled by processing that terminal program 30 installed in the terminal device 10 causes a CPU 16 to execute.

The deletion request unit 106, in response to an input operation accepted by an input acceptance unit 101, sends a deletion request for content for deleting content registered in a retrieval apparatus 20 to the retrieval apparatus 20.

The retrieval apparatus 20 illustrated in FIG. 20 includes a deletion processing unit 208. The function unit is enabled by processing that retrieval program 40 installed in the retrieval apparatus 20 causes a CPU 16 to execute.

The deletion processing unit 208 performs a deletion process for content. The deletion processing unit 208 includes a set acquisition unit 221, a deletion determination unit 222 and a deletion unit 223.

The set acquisition unit 221 acquires a content set table included in a content set DB 207 in response to the deletion request for content.

The deletion determination unit 222 determines whether the content set table acquired by the set acquisition unit 221 includes content set data of content data related to the deletion request.

The deletion unit 223, according to the determination result of the deletion determination unit 222, deletes content set data of content data related to the deletion request from the content set table. Moreover, the deletion unit 223 deletes the content data related to the deletion request from the content DB 205.

<Details of Process>

Next, details of the process of the retrieval system 1 according to the third embodiment will be described.

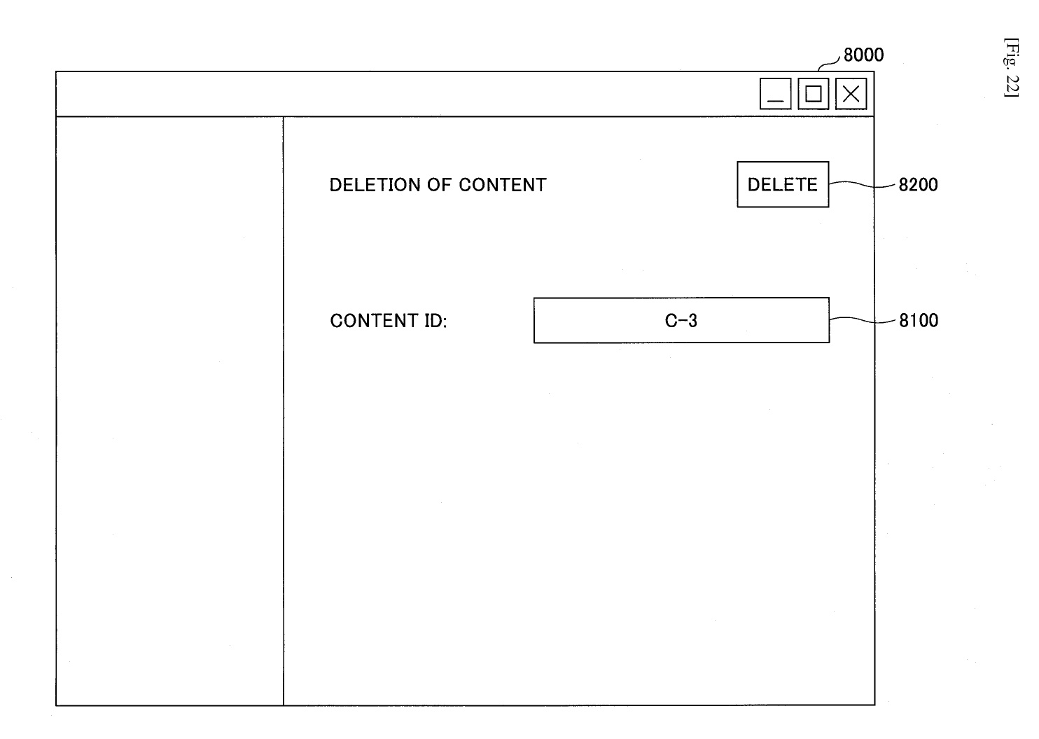

In the following, a process of deleting content registered in the retrieval apparatus 20 by the user U₂ will be described with reference to FIG. 21. FIG. 21 is a sequence diagram depicting an example of the deletion process for content according to the third embodiment.

At first, the user U₂ performs a display operation for displaying a deletion screen for content on a display device 12 of the terminal device 10 (step S2101). Then, the input acceptance unit 101 of the terminal device 10 accepts the display operation.

When the acceptance unit 101 accepts the display operation for displaying the deletion screen for content, displays a deletion screen for content 8000, for example, illustrated in FIG. 22 on the display device 12 (step S2102).

Here, the deletion screen for content 8000 illustrated in FIG. 22 is a screen for the user U₂ to delete content registered in the retrieval apparatus 20. The deletion screen for content 8000 includes a deletion ID field 8100 for inputting a content ID of content to be deleted. Moreover, the deletion screen for content 8000 includes a deletion button 8200 for deleting the content of the content ID inputted to the deletion ID field 8100.

The user U₂ performs a deletion operation for content in the deletion screen for content 8000 (step S2103). That is, the user U₂, in the deletion screen for content 8000, for example, inputs “C-3” in the deletion ID field 8100, and holds down the deletion button 8200, to perform the deletion operation for content. Then, the input acceptance unit 101 of the terminal device 10 accepts the deletion operation.

When the input acceptance unit 101 accepts the deletion operation for content, the deletion request unit 106 of the terminal device 10 sends a deletion request for content to the retrieval apparatus 20 (step S2104). Here, the deletion request includes the content ID of the content to be deleted.

The deletion processing unit 208 of the retrieval apparatus 20, when receiving the deletion request for content, performs an update process for content set of deleting the content set data of the content related to the deletion request from the content set table to update the content set (step S2104). The update process for content set will be described later in detail.

The deletion processing unit 208 of the retrieval apparatus 20, when performing the update process for content set, deletes content data of the content ID included in the deletion request from the content DB 205 (step S2105). Therefore, the content specified by the user U₂ is deleted from the retrieval apparatus 20.

Subsequently, the deletion processing unit 208 of the retrieval apparatus 20, when deleting content, sends a deletion result indicating that the content is deleted to the terminal device 10 (step S1807).

Finally, the display control unit 105 of the terminal device 10 displays a deletion result screen indicating that the content is deleted on the display device 12 (step S2108).

As described above, in the retrieval system 1 of the embodiment, by the user U₂, using the terminal device 10, content registered in the retrieval apparatus 20 is deleted. Moreover, at this time, in the retrieval system 1 of the embodiment, the deleted content is removed from the content set. Accordingly, in the retrieval system 1 of the embodiment, in response to deletion of content, indices for retrieving content (i.e. content set) can be dynamically updated.

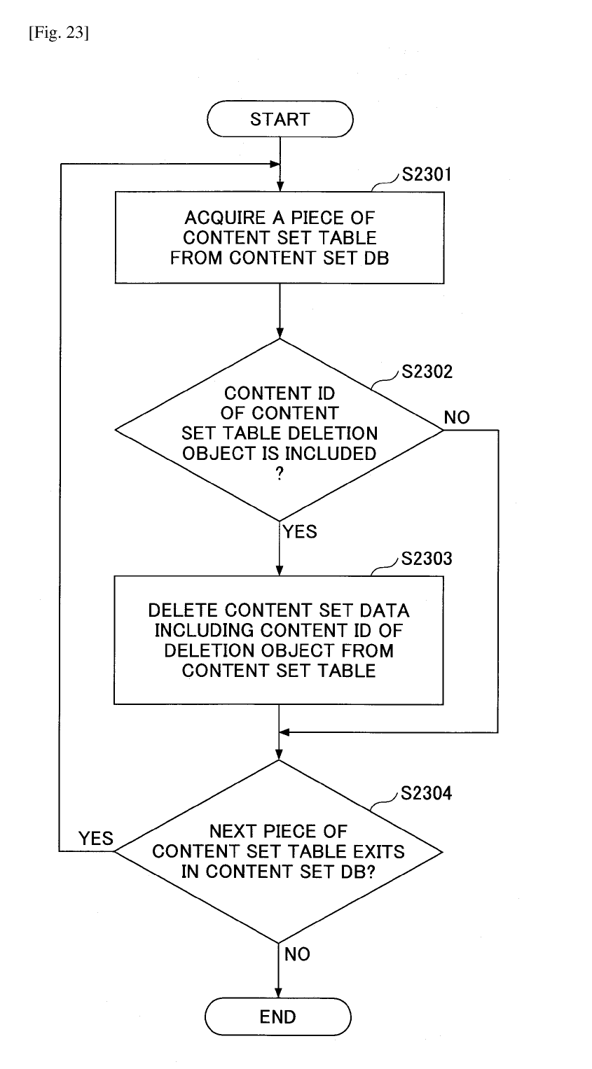

Next, the update process for content set at step S2105 will be described in detail with reference to FIG. 23. FIG. 23 is a flowchart depicting an example of the update process for content set according to third embodiment.

At first, the set acquisition unit 221 of the deletion processing unit 208 acquires a piece of content set table from the content set DB 207 (step S2301).

Next, when the content set table is acquired by the set acquisition unit, the deletion determination unit 222 of the deletion processing unit 208 determines whether the content set table includes the content set data of the content ID included in the deletion request (step S2302).

When the deletion determination unit 222 determines that the content set table includes the content set data of the content ID included in the deletion request at step S2302, the deletion unit 223 deletes the content set data from the content set table (step S2303).

When the deletion determination unit 222 determines that the content set table does not include the content set data of the content ID included in the deletion request at step S2302, the deletion processing unit 208 proceeds to step S2304.

Subsequently, the set acquisition unit 221 of the deletion processing unit 208 determines whether next content set table exists in the content set DB 207 (step S2304).

When the set acquisition unit 221 determines that next content set table exists in the content set DB 207 at step S2304, the deletion processing unit 208 returns to step S2301. That is, the deletion processing unit 208 performs the process of steps S2301 through S2304 for all content set tables stored in the content set DB 207.

When the set acquisition unit 221 determines that next content set table does not exist in the content set DB 207 at step S2304, the deletion processing unit 208 ends the process.

As described above, in the retrieval system 1 according to the embodiment, the content set data corresponding to the content to be deleted specified by the user U₂ are deleted from the content set table. In this way, in the retrieval system 1 according to the embodiment, in response to deletion of content, content set that is an index of content can be updated dynamically.

Although the present invention has been described with reference to embodiments, the present invention is not limited to these embodiments, but various variations and modifications may be made without departing from the scope of the invention as set forth in the accompanying claims.

The present application is based on and claims the benefit of priority of Japanese Priority Application No. 2015-166703 filed on Aug. 26, 2015, the entire contents of which are hereby incorporated by reference.

### INDUSTRIAL APPLICABILITY

The present invention can be applied to a retrieval system and a retrieval apparatus.

### REFERENCE SIGNS LIST

10 terminal device
20 retrieval apparatus
30 terminal program
40 retrieval program
101 input acceptance unit
102 registration request unit
103 acquisition request unit
104 retrieval request unit
105 display control unit
201 registration processing unit
202 set acquisition processing unit
203 retrieval processing unit
204 content acquisition processing unit
205 content DB
206 set definition DB
207 content set DB
211 registration unit
212 acquisition unit
213 determination unit
214 index unit
215 set unit
N network

1. A retrieval system for retrieving content data stored in a database using an index, comprising:
a first registration unit configured to register a set definition including an index object item indicating a data item serving as the index and an acquisition condition for acquiring the content data from the database;
an acquisition unit configured to acquire, when the set definition is registered by the first registration unit, content data included in the set definition, which satisfy the acquisition condition, from the database; and
a generation unit configured to extract the index object item included in the set definition, to generate the index, in the content data acquired by the acquisition unit.

2. The retrieval system according to claim 1, further comprising:
a second registration unit configured to register the content data in the database; and
a determination unit configured to determine whether the content data satisfy the acquisition condition included in the set definition registered by the first registration unit, when the content data are registered in the database by the second registration unit,
wherein the generation unit is configured to extract,
when the determination unit determines that the content data satisfy the acquisition condition, the index object item in the content data, to generate the index.

3. The retrieval system according to claim 1,
wherein the generation unit is configured to set,
when the index object item is not included in the content data, the index object item to a predetermined value, to generate the index.

4. The retrieval system according to claim 3, wherein
the predetermined value is a blank or a null.

5. The retrieval system according to claim 1,
wherein in the database, content data including first content data expressed by a first data structure and a second content data expressed by a second data structure are stored.

6. A retrieval apparatus for retrieving content data stored in a database using an index, comprising:
a first registration unit configured to register a set definition including an index object item indicating a data item serving as the index and an acquisition condition for acquiring the content data from the database;
an acquisition unit configured to acquire, when the set definition is registered by the first registration unit, content data included in the set definition, which satisfy the acquisition condition, from the database; and
a generation unit configured to extract the index object item included in the set definition to generate the index, in the content data acquired by the acquisition unit.

7. A retrieval apparatus, which is configured to retrieve content data stored in a database using an index, comprising:
circuitry configured to
register a set definition including an index object item indicating a data item serving as the index and an acquisition condition for acquiring the content data from the database;
acquire, when the set definition is registered, content data included in the set definition, which satisfy the acquisition condition, from the database; and
extract the index object item included in the set definition, to generate the index, in the acquired content data.
